(19) United States
(12) Patent Application Publication
(10) Pub. No.: US 2026/0042717 A1
(43) Pub. Date: Feb. 12, 2026

(54) METHOD FOR CONVERTING MELTED OR DISSOLVED WASTE PLASTIC IN A FLUIDIZED CATALYTIC CRACKER AND/OR IN A HYDROCRACKING UNIT

(71) Applicant: Eastman Chemical Company, Kingsport, TN (US)

(72) Inventors: David Eugene Slivensky, Tatum, TX (US); Daryl Bitting, Longview, TX (US); Nick Allen Collins, Fall Branch, TN (US); Michael Gary Polasek, Richmond, TX (US); Xianchun Wu, Longview, TX (US)

(73) Assignee: Eastman Chemical Company, Kingsport, TN (US)

(21) Appl. No.: 19/099,062

(22) PCT Filed: Jul. 20, 2023
(86) PCT No.: PCT/US2023/070560

§ 371 Date: Jan. 28, 2025

Related U.S. Application Data
(60) Provisional application No. 63/370,238, filed on Aug. 3, 2022.

(51) Int. Cl. C07C 4/06; C10G 11/18; C10G 55/06

(52) U.S. Cl. CPC C07C 4/06; C10G 11/18; C10G 55/06; C10G 2300/1003; C10G 2400/06

(57) ABSTRACT

Processes and facilities for producing a recycled content organic chemical compound directly or indirectly from waste plastic. Processing schemes are described herein for converting waste plastic (or hydrocarbon having recycled content derived from waste plastic) into useful intermediate chemicals and final products. The waste plastic can be liquified before being introduced to downstream processing. In some aspects, recycled content aromatics (r-aromatics) can be processed to provide recycled content paraxylene (r-paraxylene), which can then be used to provide recycled content terephthalic acid (r-TPA) and/or recycled content polyethylene terephthalate (r-PET).

### BACKGROUND

Aromatic compounds such as benzene, toluene, and xylenes are important industrial chemicals used in a variety of applications. Para-xylene is used to form dicarboxylic acids and esters, which are key chemical feedstocks in the production of polyesters and aromatics-based plasticizers. Most conventional production routes for these materials utilize fossil fuel-derived feeds. Thus, it would be desirable to find additional synthesis routes for para-xylene and other aromatics that are sustainable, while also providing high-purity end products. Advantageously, the manufacture of such components can be carried out with existing equipment and facilities.

When waste plastics are used as feedstock in chemical recycling processes, the solid plastic material may not be utilized in certain unit operations, which require liquified feeds, particularly for existing equipment. Thus, it would be desirable to provide the waste plastic in liquid form for use in certain refinery unit operations.

### SUMMARY

In one aspect, the present technology concerns a chemical recycling process comprising: (a) liquifying waste plastic to form a liquified waste plastic stream; and (b) introducing at least a portion of the liquified waste plastic stream into a fluidized catalytic cracker (FCC) unit and/or a hydrocracking unit.

In one aspect, the present technology concerns a chemical recycling process comprising: (a) melting waste plastic to form a liquified waste plastic stream; (b) dehalogenating at least a portion of the liquified waste plastic stream to form a halogen-depleted liquified waste plastic stream; and (c) introducing at least a portion of the halogen-depleted liquified waste plastic stream into a fluidized catalytic cracker (FCC) unit and/or a hydrocracking unit.

In one aspect, the present technology concerns a chemical recycling process comprising: (a) liquifying waste plastic to form a liquified waste plastic stream; (b) pyrolyzing at least a first portion of the liquified waste plastic to thereby provide a recycled content pyrolysis oil (r-pyoil); and (c) catalytically cracking at least a second portion of the liquified waste plastic, wherein at least a portion of the r-pyoil is combined with at least a portion of the waste plastic before or during the liquifying (a), and/or wherein at least a portion of the r-pyoil is combined with at least a portion of the liquified waste plastic after the liquifying (a).

In one aspect, the present technology concerns a method for producing recycled content para-xylene (r-pX), the method comprising: (a) liquifying waste plastic to form a liquified waste plastic stream; (b) introducing at least a portion of the liquified waste plastic stream and a refinery stream (e.g., VGO, AGO) into a fluidized catalytic cracker (FCC) unit and/or a hydrocracking (HDC) unit; (c) recovering a recycled content FCC naphtha (r-FCC naphtha) stream from the FCC unit and/or a recycled content HDC naphtha (r-HDC naphtha) stream from the HDC unit, wherein the r-FCC naphtha stream and/or the r-HDC naphtha stream comprises at least one aromatics-containing stream and/or wherein the r-FCC naphtha stream and/or the r-HDC naphtha stream are further processed to produce at least one aromatics-containing stream; (d) processing at least a portion of the at least one aromatics-containing stream within an aromatics complex to produce an r-pX-containing product stream comprising at least 85 weight percent para-xylene.

In one aspect, the present technology concerns a method for producing a recycled content organic chemical compound (r-organic chemical compound), the method comprising: (a) introducing a recycled content aromatics-containing stream into an aromatics complex, wherein the aromatics-containing stream comprising a recycled content FCC naphtha (r-FCC naphtha) stream, a recycled content reformate (r-reformate) stream, and/or a recycled content pyrolysis gasoline (r-pyrolysis gasoline) stream, wherein: (i) the r-FCC naphtha stream is obtained by catalytically cracking a liquified waste plastic material; (ii) the r-reformate stream is obtained by reforming at least a first portion of the r-FCC naphtha stream; and/or (iii) the r-pyrolysis gasoline stream is obtained by steam cracking at least a second portion of the r-FCC naphtha stream, optionally with a recycled content light gas; and (b) processing the aromatics-containing stream in the aromatics complex to provide an r-pX stream comprising at least 85 weight percent para-xylene.

In one aspect, the present technology concerns a method for producing a recycled content organic chemical compound (r-organic chemical compound), the method comprising: (a) introducing a stream of recycled content paraxylene (r-pX) into a terephthalic acid (TPA) production facility, wherein at least a portion of the r-pX is obtained by liquifying waste plastic to form a liquified waste plastic stream, introducing at least a portion of the liquified waste plastic stream into a fluidized catalytic cracker unit and/or a hydrocracker unit, recovering a recycled content FCC naphtha (r-FCC naphtha) stream from the FCC unit and/or a recycled content HDC naphtha (r-HDC naphtha) stream from the hydrocracker unit, wherein the r-FCC naphtha stream and/or the r-HDC naphtha stream comprises at least one aromatics-containing stream and/or wherein the r-FCC naphtha stream and/or the r-HDC naphtha stream are further processed to produce at least one aromatics-containing stream, and processing at least a portion of the at least one aromatics-containing stream in an aromatics complex to produce the stream of r-pX; and (b) processing at least a portion of the r-pX in the TPA production facility to provide recycled content purified terephthalic acid (r-PTA).

### BRIEF DESCRIPTION OF THE DRAWINGS

FIG. 1 is a schematic block flow diagram illustrating the main processes/facilities in a system for providing recycled content organic chemical compounds, including r-paraxylene, r-terephthalic acid, and r-polyethylene terephthalate, according to various embodiments of the present invention;

FIG. 2 is a schematic block flow diagram illustrating the main steps/zones in a pyrolysis facility suitable for use in the system illustrated in FIG. 1;

FIG. 3 is a schematic block flow diagram illustrating the main steps/zones in a refinery suitable for catalytically cracking a liquified waste plastic, according to various embodiments of the present invention;

FIG. 4 is a schematic block flow diagram illustrating the main steps/zones in a refinery suitable for catalytically cracking and/or hydrocracking a liquified waste plastic, according to various embodiments of the present invention;

FIG. 5 is a schematic diagram of an FCC unit configured to process recycled content feed streams in a refinery as shown in FIG. 1;

FIG. 6 is a schematic block flow diagram illustrating the main steps/zones in an aromatics complex suitable for use in the system illustrated in FIG. 1;

FIG. 7A is a block flow diagram illustrating the main steps of a process for making recycled content aromatics (r-aromatics) and recycled content paraxylene (r-paraxylene), and optionally, a recycled content organic chemical compound from the r-paraxylene, wherein the r-aromatics (and r-paraxylene and r-organic chemical compound) have physical content from one or more source materials; and

FIG. 7B is a block flow diagram illustrating the main steps of a process for making recycled content aromatics (r-aromatics) and recycled content paraxylene (r-paraxylene), and optionally, a recycled content organic chemical compound from the r-paraxylene, wherein the r-aromatics (and r-paraxylene and r-organic chemical compound) have credit-based recycled content from one or more source materials.

### DETAILED DESCRIPTION

We have discovered a method for producing a recycled content organic chemical compound from hydrocarbon streams with recycled content derived from waste plastic. In particular, we have discovered new methods and systems for producing paraxylene and organic chemical compounds formed by directly processing paraxylene or its derivatives, including, for example, organic chemical compounds such as terephthalic acid and polyethylene terephthalate. More specifically, we have discovered a process and system for producing paraxylene where recycled content from waste materials, such as waste plastic, are applied to paraxylene (or its derivatives) in a manner that promotes the recycling of waste plastic and provides paraxylene (or other organic chemical compounds) with substantial amounts of recycled content. The process and system are particularly suitable for liquifying waste plastic to be used as a feedstock to one or more downstream refinery processes.

In particular, we have discovered new methods and systems for producing paraxylene and organic chemical compounds formed by directly processing paraxylene or its derivatives, including, for example, organic chemical compounds such as terephthalic acid and polyethylene terephthalate. More specifically, we have discovered a process and system for producing paraxylene where recycled content from waste materials, such as waste plastic, are applied to paraxylene (or its derivatives) in a manner that promotes the recycling of waste plastic and provides paraxylene (or other organic chemical compounds) with substantial amounts of recycled content.

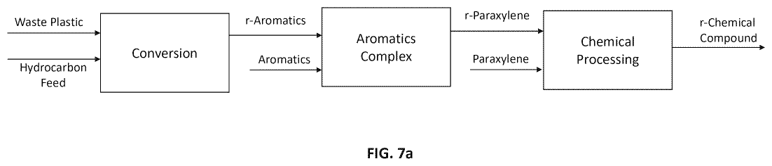

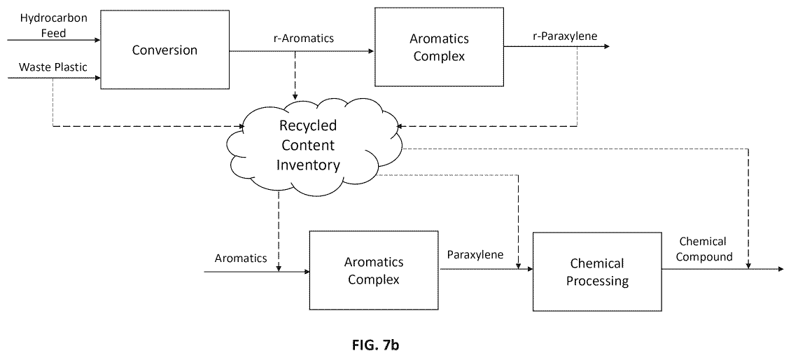

Turning initially to FIGS. 7A and 7B, paraxylene is formed by processing a predominantly aromatics stream in an aromatics complex to provide a stream including at least 85, at least 90, at least 92, at least 95, at least 97, or at least 99 weight percent paraxylene. The paraxylene stream can undergo one or more additional processing steps to provide at least one organic chemical compound derived from paraxylene. Examples of such organic chemical compounds include, but are not limited to, terephthalic acid, polymers such as polyethylene terephthalate, and other related organic chemical compounds.

As generally shown in FIGS. 7A and 7B, a stream of waste plastic processed in one or more conversion facilities may provide the aromatics stream, which can be processed to form the paraxylene stream. The recycled content in the paraxylene stream can be physical and may directly originate from waste plastic or an intermediate hydrocarbon stream formed by processing waste plastic, and/or the recycled content may be credit based and can be applied to a target stream in the aromatics complex and/or chemical processing facilities.

The aromatics (or paraxylene or organic chemical compound) streams can have a total recycled content of at least 5, at least 10, at least 15, at least 20, at least 25, at least 30, at least 35, at least 40, at least 45, at least 50, at least 55, or at least 65 percent and/or 100 percent, or less than 99, less than 95, less than 90, less than 85, less than 80, less than 75, or less than 70 percent. Similarly, the r-TPA and/or r-PET or even the r-aromatics stream can have a recycled content of at least 5, at least 10, at least 15, at least 20, at least 25, at least 30, at least 35, at least 40, at least 45, at least 50, at least 55, or at least 65 percent and/or 100 percent, or less than 99, less than 95, less than 90, less than 85, less than 80, less than 75, or less than 70 percent. The recycled content in one or more of these streams can be physical recycled content, credit-based recycled content, or a combination of physical and credit-based recycled content.

Turning initially to FIG. 7A, in one embodiment or in combination with one or more embodiments mentioned herein, at least a portion of the recycled content in the aromatics and/or paraxylene stream (or in the organic chemical compound product stream) can be physical (direct) recycled content. This recycled content may originate from a waste plastic stream. The waste plastic stream is ultimately converted in one or more conversion facilities (e.g., a pyrolysis facility, a refinery, a steam cracking facility, and/or a molecular reforming facility and methanol-to-aromatics facility), which is processed (alone or with a non-recycled content aromatics stream) as described herein to provide an r-paraxylene stream. The r-paraxylene stream can then be further processed (along or in combination with a non-recycled content paraxylene stream) to provide a recycled content organic chemical compound, including, but not limited to, recycled content terephthalic acid (r-TPA), recycled content polyethylene terephthalate (r-PET), and one or more additional recycled content organic chemical compounds (r-organic chemical compounds).

The amount of physical recycled content in the target product (e.g. composition, r-aromatics or r-paraxylene or r-organic chemical compound) can be determined by tracing the amount of waste plastic material processed along a chain of chemical pathway(s) and ending with the moiety or portion of the target product attributable to the waste plastic chemical pathway. As used herein, a moiety can be a portion the atoms and their structure of a target product and can also include the entire chemical structure of the target product and does not necessarily require the inclusion of a functional group. For example, a moiety of p-xylene can include the aromatic ring, a portion of the aromatic ring, the methyl groups, or the entire p-xylene molecule. The chemical pathway includes all chemical reactions and other processing steps (e.g., separations) between the starting materials (e.g., waste plastic) and the moiety in the target product attributable to the chemical pathway originating in waste plastics. For example, the chemical pathway for the r-aromatics can include pyrolysis, optionally refining and/or stream cracking, and/or molecular reforming and methanol synthesis and conversion. The chemical pathway for the r-paraxylene can further include processing in the aromatics complex, and the chemical pathway for the r-organic chemical compound may include a variety of additional steps, such as, for example, oxidation, polymerization, etc., depending on the specific r-organic chemical compound. A conversion factor may be associated with each step along the chemical pathway. The conversion factors account for the amount of the recycled content diverted or lost at each step along the chemical pathway. For example, the conversion factors can account for the conversion, yield, and/or selectivity of the chemical reactions along the chemical pathway.

The amount of credit-based recycled content in a target product (e.g. compositions, r-aromatics or r-paraxylene or r-organic chemical compounds) can be determined by calculating the mass weight percent of a target moiety in a target product and attributing a recycle content credit to the target product in any amount up to the mass weight percent of the target moiety in the target product as a maximum. The credit based recycle content that is eligible to be applied to the target product is determined by tracing the waste plastic material along a chain of chemical pathway(s) and ending with the same moiety as target moiety in the target product. Thus, the credit based recycle content can be applied to a variety of different target products having the same moiety even though the products are made by entirely different chemical pathways provided that the credit applied is obtained from waste plastic and the waste plastic ultimately undergoes at least one chemical pathway originating from waste plastic and ending in the target moiety. For example, if a recycle content credit is obtained from waste plastic and booked into a recycle content inventory, and there exists chemical pathways at the facility capable of processing the waste plastic through to a target moiety such as p-xylene (e.g. a pyrolysis reactor effluent to a crude distillation column to a hydrotreater to a reformer to an aromatics complex that isolates p-xylene), the recycle content credit is then a type eligible to apply to any p-xylene molecule made by any chemical pathway, including the one existing at the facility and/or to the p-xylene portion of a pyrolysis gasoline stream composition obtained from a steam cracker and gasoline fractionator. As with physical recycled content, a conversion factor may or may not be associated with each step along the chemical pathway. Additional details on credit-based recycled content are provided below.

The amount of recycled content applied to the r-aromatics (or r-paraxylene or r-organic chemical compound) can be determined using one of variety of methods for quantifying, tracking, and allocating recycled content among various materials in various processes. One suitable method, known as “mass balance,” quantifies, tracks, and allocates recycled content based on the mass of the recycled content in the process. In certain embodiments, the method of quantifying, tracking, and allocating recycled content is overseen by a certification entity that confirms the accuracy of the method and provides certification for the application of recycled content to the r-aromatics (or r-paraxylene or r-organic chemical compound).

Turning now to FIG. 7B, one embodiment where the r-organic chemical compound (or r-paraxylene) includes credit-based recycled content, is provided. Recycled content credits from waste plastic are attributed to one or more streams within the facility. For example, the recycled content credits derived from waste plastics can be attributed to the aromatics stream fed to the aromatics complex, or to any of the products separated and isolated in the aromatics complex, such as to the paraxylene stream. Alternatively, or in addition, recycled content credits obtained from one or more intermediate streams within the conversion facility and/or aromatics complex can also be attributed to one or more products, such as paraxylene, within the facility, depending on the specific configuration of the system. Further, recycled content credits from one or more of these streams may also be attributed to the organic chemical compound stream, as shown in FIG. 7B.

As such, the waste plastic stream, or the r-aromatics stream and r-paraxylene streams (and any recycled content intermediate streams not shown in FIG. 7B) not made at the facility or purchased or acquired, can each act as a “source material” of recycled content credits. The aromatics fed to the aromatics complex, the paraxylene product or any other products separated and/or isolated from the aromatics complex, the paraxylene transferred (including sales) or fed to the chemical processing facility, any intermediate streams not shown, and even the organic chemical compound, can each act as a target product to which the recycled content credits are attributed. In one embodiment or in combination with any embodiment mentioned herein, the source material has physical recycled content and the target product has less than 100 percent physical recycled content. For example, the source material can have at least 10, at least 25, at least 50, at least 75, at least 90, at least 99, or 100 percent physical recycled content and/or the target product can have less than 100, less than 99, less than 90, less than 75, less than 50, less than 25, less than 10, less than 1 percent, or no physical recycled content.

The ability to attribute recycled content credits from a source material to a target product removes the co-location requirement between the facility making the source material (with physical recycled content) and the facility making the aromatics or products receiving recycle content value (e.g. paraxylene or organic chemical compound). This allows a chemical recycling facility/site in one location to process waste material into one or more recycled content source materials and then apply recycled content credits from those source materials to one or more target products being processed in existing commercial facilities located remotely from the chemical recycling facility/site, optionally within the same Family of Entities, or to associate a recycle content value with a product that is transferred to another facility, optionally owned by a different entity that can deposit the recycle content credit into its recycle content inventory one the product is receiving, purchased, or otherwise transferred. Further, the use of recycled content credits allows different entities to produce the source material and the aromatics (or paraxylene or organic chemical compound). This allows efficient use of existing commercial assets to produce the aromatics (or paraxylene or organic chemical compound). In one or more embodiments, the source material is made at a facility/site that is at least 0.1, at least 0.5, at least 1, at least 5, at least 10, at least 50, at least 100, at least 500, or at least 1000 miles from the facility/site where the target product is used to make the aromatics (or paraxylene or organic chemical compound).

The attributing of recycled content credits from the source material (e.g., the r-aromatics from the conversion facility) to the target product (e.g., an aromatics stream fed to an aromatics complex) can be accomplished by transferring recycled content credits directly from the source material to the target product. Alternatively, as shown in FIG. 7B, recycled content credits can be applied from any of the waste plastic, r-aromatics, and r-paraxylene (when present) to the aromatics, paraxylene, or organic chemical compound via a recycled content inventory.

When a recycled content inventory is used, recycled content credits from the source material having physical recycled content (e.g., the waste plastic, the r-aromatics, and optionally the r-paraxylene shown in FIG. 7B) are booked into the recycled content inventory. The recycled content inventory can also contain recycled content credits from other sources and from other time periods. In one embodiment, recycled content credits in the recycled content inventory correspond to a moiety, and the recycle content credit is applied or assigned to the same a target products containing a target moiety, and the target moiety is either (i) not chemically traceable through chemical pathways used to for generating the recycle content credit or (ii) is chemically traceable through chemical pathways used for generating the recycle content credit. Chemical traceability is achieved when atoms from a source material such as waste plastic can be theoretically traced to one or more atoms in the target moiety of a target product through each chemical pathway to obtain that atom(s) in the target moiety.

In some embodiments, there may be a periodic (e.g., annual or semi-annual) reconciliation between waste plastic credits deposited in the recycled content inventory and the mass of waste plastic processed. Such reconciliations may be performed by an appropriate entity at an interval consistent with rules of the certification system in which the producer is participating.

In one embodiment, once recycled content credits have been attributed to the target product (e.g., the aromatics stream, the paraxylene stream, or any intermediate stream not shown), the amount of the credit-based recycled content allocated to the organic chemical compound (e.g., TPA, PET, or other organic chemical compound) is calculated by the mass proportion of atoms in the target product that are chemically traceable to the source material. In another embodiment, a conversion factor can be associated with each step along the chemical pathway of the credit-based recycled content. The conversion factors account for the amount of the recycled content diverted or lost at each step along the chemical pathway. For example, the conversion factors can account for the conversion, yield, and/or selectivity of the chemical reactions along the chemical pathway. However, if desired, the amount of recycle content applied to a target product can be more than the mass proportion of the target moiety chemically traceable to the waste plastic source material. The target product can receive up to 100% recycle content even though the mass proportion of atoms in the target moiety that is chemically traceable to a recycle source material, such as mixed plastic waste stream, is less than 100%. For example, if the target moiety in a product represents only 30 wt. % of all atoms in a target product that are chemically traceable to a mixed plastic waste stream, the target product can nevertheless receive more than 30% recycle content value, up to 100% if desired. While such application would violate chemical traceability for the full value of the amount of recycle content in a target product back to a waste plastic source, the particular amount of recycle content value applied to a target product will depend on the rules of a certification system that the producer participates in.

As with the physical recycled content, the amount of credit-based recycled content applied to the r-aromatics (or r-paraxylene or r-organic chemical compound) can be determined using one of variety of methods, such as mass balance, for quantifying, tracing, and allocating recycled content among various products in various processes. In certain embodiments the method of quantifying, tracing, and allocating recycled content is overseen by a certification entity that confirms the accuracy of the method and provides certification for the application of recycled content to the r-aromatics (or r-paraxylene or r-organic chemical compound).

The r-aromatics (or r-paraxylene or r-organic chemical compound) can have 25 to 90, 40 to 80, or 55 to 65 percent credit-based recycled content and less than 50, less than 25, less than 10, less than 5, or less than 1 percent physical recycled content. In certain embodiments, the r-aromatics (or r-paraxylene or r-organic chemical compound) can have at least 10, at least 25, at least 50, or at least 65 percent and/or not more than 90, not more than 80, or not more than 75 percent credit-based recycled content from one or more of the r-aromatics and/or r-paraxylene, individually.

In one or more embodiments, the recycled content of the r-aromatics (or r-paraxylene or r-organic chemical compound) can include both physical recycled content and credit-based recycled content. For example, the r-aromatics (or r-paraxylene or r-organic chemical compound) can have at least 10, at least 20, at least 30, at least 40, or at least 50 percent physical recycled content and at least 10, at least 20, at least 30, at least 40, or at least 50 percent credit-based recycled content. As used herein, the term “total recycled content” refers to the cumulative amount of physical recycled content and credit-based recycled content from all sources.

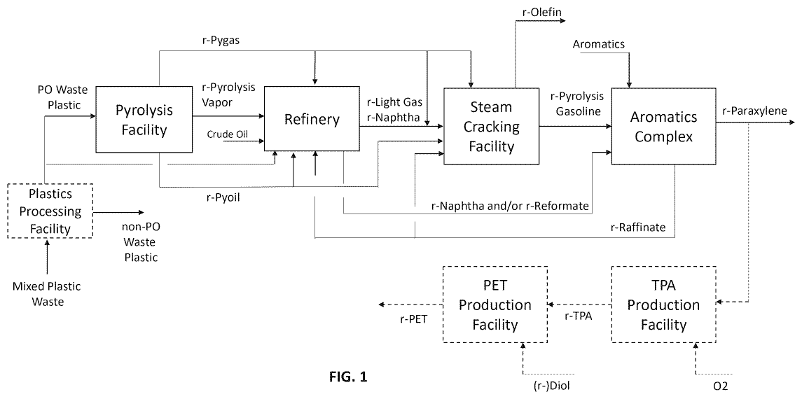

Turning now to FIG. 1, a process and facility for use in forming a recycled content organic chemical compound is provided. As used herein, the term “organic chemical compound,” refers to a chemical compound that includes carbon and hydrogen atoms, but also includes oxygen and/or nitrogen atoms. An organic chemical compound can include at least 75, at least 80, at least 85, at least 90, at least 95, or at least 99 atom percent of carbon and hydrogen atoms combined, with the balance being nitrogen and oxygen.

Specifically, the system illustrated in FIG. 1 can form recycled content paraxylene (r-paraxylene) from one or more streams having recycled content derived from waste plastic. The system shown in FIG. 1 includes an optional plastics processing facility, pyrolysis facility, a refinery, a steam cracking facility, and an aromatics complex. Optionally, at least a portion of the r-paraxylene can be oxidized to form recycled content terephthalic acid (r-TPA) in a TPA production facility and at least a portion of the r-TPA can be reacted with at least one diol to form recycled content polyethylene terephthalate (r-PET) in a PET production facility. The r-paraxylene formed as described herein may be used in other applications not illustrated in FIG. 1.

The facility shown in FIG. 1 can be a chemical recycling facility. Chemical recycling facilities are not the same as mechanical recycling facilities. As used herein, the terms “mechanical recycling” and “physical recycling” refer to a recycling process that includes a step of melting waste plastic and forming the molten plastic into a new intermediate product (e.g., pellets or sheets) and/or a new end product (e.g., bottles). Generally, mechanical recycling does not substantially change the chemical structure of the plastic being recycled. The chemical recycling facilities described herein may be configured to receive and process waste streams from and/or that are not typically processable by a mechanical recycling facility.

In one embodiment or in combination with any embodiments mentioned herein, at least two, at least three, at least four, at least five, or all of the pyrolysis facility, the refinery, the steam cracking facility, the aromatics complex, and the optional TPA production facility and the optional PET production facility may be co-located. As used herein, the term “co-located” refers to the characteristic of at least two objects being situated on a common physical site, and/or within 5, within 3, within 1, within 0.75, within 0.5, or within 0.25 miles of each other, measured as a straight-line distance between two designated points.

When two or more facilities are co-located, the facilities may be integrated in one or more ways. Examples of integration include, but are not limited to, heat integration, utility integration, waste-water integration, mass flow integration via conduits, office space, cafeterias, integration of plant management, IT department, maintenance department, and sharing of common equipment and parts, such as seals, gaskets, and the like.

Additionally, one or more, two or more, three or more, four or more, five, or all, of the pyrolysis facility, the refinery, the steam cracking facility, the aromatics complex, the TPA production facility, and the PET production facility may be commercial-scale facilities. For example, in one embodiment or in combination with any embodiments mentioned herein, one or more of these facilities/steps can accept one or more feed streams at a combined average annual feed rate of at least 500, at least 1000, at least 1500, at least 2000, at least 5000, at least 10,000, at least 50,000, or at least 100,000 pounds per hour, averaged over one year. Further, one or more of the facilities can produce at least one recycled content product streams at an average annual rate of at least 500, or at least 1000, at least 1500, at least 2000, at least 2500, at least 5000, at least 10,000, at least 50,000, or at least 75,000 pounds per hour, averaged over one year. When more than one r-product stream is produced, these rates can apply to the combined rate of all r-products.

One or more, two or more, three or more, four or more, five, or all, of the pyrolysis facility, the refinery, the steam cracking facility, the aromatics complex, the TPA production facility, and the PET production facility can be operated in a continuous manner. For example, each of the steps or processes within each of the facilities and/or the process amongst the facilities may be operated continuously and may not include batch or semi-batch operation. In one embodiment or in combination with any embodiments mentioned herein, at least a portion of one or more of the facilities may be operated in a batch or semi-batch manner, but the operation amongst the facilities may be continuous overall.

As shown in FIG. 1, a stream of mixed waste plastic may be passed through an optional plastics processing facility. The plastics processing facility, when present, can separate mixed plastic into PET-enriched and a polyolefin (PO)-enriched streams and these separated streams can be introduced into separate conversion facilities. Additionally, or in the alternative, the plastics processing facility may also reduce the size of the incoming plastic via a cutting, crushing, flaking, pelletizing, grinding, granulating, and/or pulverizing step. The waste plastic may also be melted or combined with a solvent to form a liquified plastic (as described in greater detail below) or a slurry. One or more cleaning or separation steps may also be present to remove water or moisture, dirt, food, sand, glass, metals such as aluminum, copper and iron, lignocellulosic materials such as paper and cardboard, from the incoming waste stream.

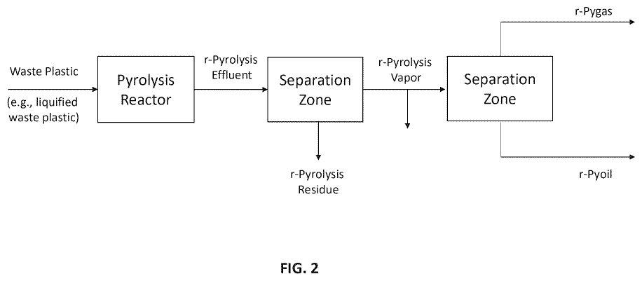

As shown in FIG. 1, waste plastic, which can include PO-enriched waste plastic, can be introduced into the pyrolysis facility, wherein it may be pyrolyzed to form at least one recycled content pyrolysis effluent stream (as depicted in FIG. 2), and/or the PO-enriched waste plastic may be introduced to a liquification zone, wherein the waste plastic may be melted or otherwise liquified, and optionally dehalogenated, before being fed into the refinery. In one embodiment or in combination with any embodiments mentioned herein, the system shown in FIG. 1 may also include a plastics processing facility for separating a stream of mixed plastic waste into a predominantly polyolefin (PO) waste plastic and a predominantly non-PO waste plastic, which typically includes waste plastics such as polyethylene terephthalate (PET), polyvinyl chloride (PVC), and others. In addition, when present, the plastics processing facility can also remove other non-plastic components, such as water, glass, metals, dirt, sand, and cardboard from the incoming waste stream.

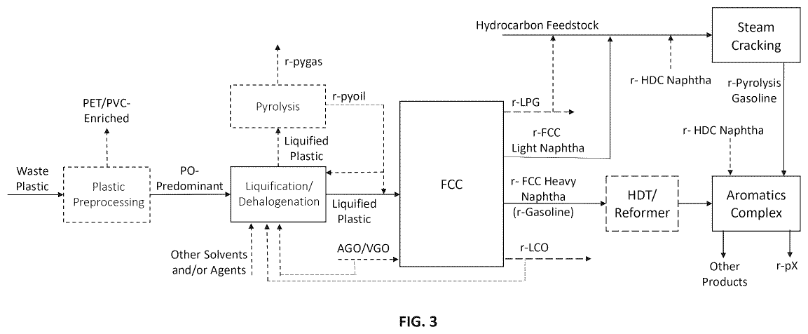

Referring now to FIG. 3, the waste plastic (which may be PO-enriched) may be introduced into a liquification zone or step prior to being introduced into one or more of the downstream processing facilities, such as the pyrolysis facility or FCC unit. As used herein, the term “liquification” zone or step refers to a chemical processing zone or step in which at least a portion of the incoming plastic is liquefied. The step of liquefying plastic can include chemical liquification, physical liquification, or combinations thereof. Exemplary methods of liquefying the polymer introduced into the liquification zone can include (i) heating/melting; (ii) dissolving or solvating in a solvent; (iii) depolymerizing; (iv) plasticizing, and combinations thereof. Additionally, one or more of options (i) through (iv) may also be accompanied by the addition of a blending or liquification agent to help facilitate the liquification (reduction of viscosity) of the polymer material. As such, a variety of rheology modification agents (e.g., solvents, depolymerization agents, plasticizers, and blending agents) can be used to enhance the flow and/or dispersibility of the liquified waste plastic.

Referring again to FIG. 3, the waste plastic may be introduced into a liquification system or step prior to being introduced into one or more of the downstream processing facilities. Additionally, or in the alternative, an unsorted waste plastic (such as unprocessed waste plastic and/or partially processed waste plastic) and/or any sorted waste plastic from the preprocessing facility or other sources may be introduced into the liquification system or step prior to being introduced into one or more of the downstream processing facilities. In an embodiment or in combination with any embodiment mentioned herein, the waste plastic fed into the liquification system or step may be provided as a waste stream from another processing facility, for example a municipal recycling facility (MRF) or reclaimer facility, or as a plastic-containing mixture comprising waste plastic sorted by a consumer and left for collection at a curbside.

In an embodiment or in combination with any embodiment mentioned herein, the plastic stream fed into the liquification system can comprise a sorted waste plastic stream that is enriched in PO and contains low amounts of PET, nylons (e.g., Nylon-6, Nylon-66), acrylonitrile butadiene styrene (ABS), and PVC, such as the PO-enriched waste plastic stream. For example, the plastic stream fed into the liquification system can comprise at least 10, at least 15, at least 25, at least 50, at least 75, or at least 90 and/or not more than 99.9, not more than 99.5, not more than 99, not more than 98, not more than 95, not more than 90, not more than 85, not more than 80, not more than 75, not more than 70, not more than 65, not more than 60, not more than 55, not more than 50, not more than 45, not more than 40, not more than 35, or not more than 30 weight percent of one or more polyolefins, based on the total weight of the stream. Additionally, or in the alternative, the plastic stream fed into the liquification system can comprise not more than 25, not more than 10, not more than 5, not more than 2, not more than 1, not more than 0.5, or not more than 0.1 weight percent of PET and/or PVC, based on the total weight of the stream.

In an embodiment or in combination with any embodiment mentioned herein, the plastic stream fed into the liquification system can comprise an unsorted waste plastic stream that comprises a notable amount of PET. For example, in one or more embodiments, the plastic stream fed into the liquification system can comprise at least 0.5, at least 1, at least 2, at least 3, at least 4, at least 5, at least 10, at least 15, at least 20, at least 25, or at least 30 and/or not more than 95, not more than 90, not more than 80, or not more than 70 weight percent of PET, based on the total weight of the stream. Additionally, or in the alternative, the plastic stream fed into the liquification system can comprise at least 5, at least 10, at least 15, at least 20, at least 25, or at least 30 and/or not more than 95, not more than 90, not more than 80, or not more than 70 weight percent of one or more polyolefins, based on the total weight of the stream.

In an embodiment or in combination with any embodiment mentioned herein, the plastic stream fed into the liquification system can comprise of at least 50, at least 75, at least 80, at least 85, at least 90, at least 95, or at least 99 weight percent of one or more solid waste plastics, based on the total weight of the feed stream being introduced into the liquification system. Thus, in one or more embodiments, the plastic stream being fed into the liquification system comprises a very high solids content.

Additionally, or in the alternative, the plastic stream fed into the liquification system can be in the form of a slurry and comprise one or more slurry-forming liquids, such as water. In such embodiments, the plastic stream fed into the liquification system can comprise at least 1, at least 2, at least 3, at least 4, at least 5, at least 10, at least 15, at least 20, or at least 25 and/or not more than 90, not more than 80, not more than 70, not more than 60, not more than 50, not more than 40, not more than 30, not more than 20, not more than 10, or not more than 5 weight percent of one or more slurry-forming liquids, based on the total weight of the feed stream being introduced into the liquification system.

When added to the liquification system, at least a portion of the plastic (usually waste plastic) undergoes a reduction in viscosity. In some cases, the reduction in viscosity can be facilitated by heating (e.g., addition of steam directly or indirectly contacting the plastic), while, in other cases, it can be facilitated by combining the plastic with a solvent capable of dissolving or solvating it.

In an embodiment or in combination with any embodiment mentioned herein, the waste plastic added to the liquification system may be at least partially dissolved or solvated by contacting the plastic with at least one solvent. Generally, the dissolving or solvating step may be carried at a pressure and temperature sufficient to at least partially dissolve the solid waste plastic. Examples of suitable solvents can include, but are not limited to, alcohols such as methanol or ethanol, glycols such as ethylene glycol, diethylene glycol, triethylene glycol, neopentyl glycol, cyclohexanedimethanol, glycerin, pyrolysis oil, motor oil, vacuum gas oil, atmospheric gas oil, light cycle oil (e.g., a hydrotreated LCO from an FCC unit), decahydronaphthalene (Decalin), heavy aromatics and heavy aromatics mixtures (such as heavier components from catalytic reforming process or stream cracking process), water, and mixtures thereof. In one or more embodiments, hydrogen pressures of 500 to 1000 psig may be needed to fully saturate both rings in the naphthalene-type species present in FCC light cycle oil when using typical hydrotreating catalysts (e.g., CoMo, NiMo). As shown in FIG. 3, the solvent stream(s) can be added directly to the liquification system, or the solvent stream(s) can be combined with one or more streams fed to the liquification system (not shown in FIG. 3). In the event that a pyrolysis oil is used as the solvent in the solvent stream, such pyrolysis oil may be derived from the pyrolysis facility (as shown) or be a pyrolysis oil purchased from an external source.

When used, the solvent may be present in an amount of at least 1, at least 2, at least 5, at least 10, at least 15, or at least 20 weight percent, based on the total weight of the feed stream introduced into the liquification system. Additionally, or in the alternative, the solvent may be present in an amount of not more than 60, not more than 50, not more than 40, not more than 30, not more than 20, or not more than 15 weight percent, based on the total weight of the feed stream introduced into the liquification system. For example, the overall feed stream introduced into the liquification system may comprise 1 to 50, 2 to 40, or 5 to 30 weight percent of one or more solvents.

In an embodiment or in combination with any embodiment mentioned herein, the solvent can comprise a stream withdrawn from one or more other facilities. For example, the solvent can comprise a stream withdrawn from at least one of the refinery process streams (e.g., atmospheric gas oil, vacuum gas oil, etc.), the pyrolysis facility (e.g., pyrolysis oil), the steam cracking facility, and/or the aromatics complex. As shown in FIG. 3, at least a portion of the pyrolysis oil stream withdrawn from the pyrolysis facility can be combined with the PO-enriched plastic stream to form a liquified plastic. Although shown as being introduced directly into the liquification system, all or a portion of the pyrolysis oil stream may be combined with the PO-enriched plastic stream prior to introduction into the liquification system, or after the PO-enriched plastic stream exits the liquification system. When used, the pyrolysis oil can be added at one or more locations described herein, alone or in combination with one or more other solvent streams.

In an embodiment or in combination with any embodiment mentioned herein, the waste plastic added to the liquification system may be depolymerized such that, for example, the number average chain length of the plastic is reduced by contact with a depolymerization agent. Generally, the depolymerizing step may be carried at a pressure and temperature sufficient to at least partially liquefy the solid waste plastic. In an embodiment or in combination with any embodiment mentioned herein, at least one of the previously-listed solvents used for dissolving may also be used as a depolymerization agent, while, in one or more other embodiments, the depolymerization agent can include an organic acid (e.g., acetic acid, citric acid, butyric acid, formic acid, lactic acid, oleic acid, oxalic, stearic acid, tartaric acid, and/or uric acid) or inorganic acid such as sulfuric acid and/or nitric acid (for polyolefin). The depolymerization agent may reduce the melting point and/or viscosity of the polymer by reducing its number average chain length.

When used, the depolymerization agent may be present in an amount of at least 1, at least 2, at least 5, at least 10, at least 15, or at least 20 weight percent, based on the total weight of the feed stream introduced into the liquification system. Additionally, or in the alternative, the depolymerization agent may be present in an amount of not more than 60, not more than 50, not more than 40, not more than 30, not more than 20, or not more than 15 weight percent, based on the total weight of the feed stream introduced into the liquification system. For example, the overall feed stream introduced into the liquification system may comprise 1 to 50, 2 to 40, or 5 to 30 weight percent of one or more depolymerization agents.

In an embodiment or in combination with any embodiment mentioned herein, the waste plastic added to the liquification system may be contacted with a plasticizer in the liquification system to reduce the viscosity of the plastic. In such embodiments, the plasticizing step may be carried out in a heated vessel, such as the melt tank described below, and/or in a mixer under agitation, such as a calendaring mixer and/or an extruder. During the plasticizing step, the plasticizers may be incorporated into the plastic while it is being liquefied in the liquification vessel. Plasticizers for polyethylene include, for example, dioctyl phthalate, dioctyl terephthalate, glyceryl tribenzoate, polyethylene glycol having molecular weight of up to 8,000 Daltons, sunflower oil, paraffin wax having molecular weight from 400 to 1,000 Daltons, paraffinic oil, mineral oil, glycerin, EPDM, and EVA. Plasticizers for polypropylene include, for example, dioctyl sebacate, paraffinic oil, isooctyl tallate, plasticizing oil (Drakeol 34), naphthenic and aromatic processing oils, and glycerin. Plasticizers for polyesters include, for example, polyalkylene ethers (e.g., polyethylene glycol, polytetramethylene glycol, polypropylene glycol or their mixtures) having molecular weight in the range from 400 to 1500 Daltons, glyceryl monostearate, octyl epoxy soyate, epoxidized soybean oil, epoxy tallate, epoxidized linseed oil, polyhydroxyalkanoate, glycols (e.g., ethylene glycol, pentamethylene glycol, hexamethylene glycol, etc.), phthalates, terephthalates, trimellitate, and polyethylene glycol di-(2-ethylhexoate). When used, the plasticizer may be present in an amount of at least 0.1, at least 0.5, at least 1, at least 2, or at least 5 weight percent and/or not more than 10, not more than 8, not more than 5, not more than 3, not more than 2, or not more than 1 weight percent, based on the total weight of the stream, or it can be in a range of from 0.1 to 10 weight percent, 0.5 to 8 weight percent, or 1 to 5 weight percent, based on the total weight of the feed stream introduced into the liquification system.

Further, one or more of the methods of liquefying the waste plastic stream can also include adding at least one liquification agent to the plastic before, during, or after the liquification process. Such liquification agents may include for example, emulsifiers and/or surfactants, and may serve to more fully blend the liquified plastic into a single phase, particularly when differences in densities between the plastic components of a mixed plastic stream result in multiple liquid or semi-liquid phases. When used, the liquification agent may be present in an amount of at least 0.1, at least 0.5, at least 1, at least 2, or at least 5 weight percent and/or not more than 10, not more than 8, not more than 5, not more than 3, not more than 2, or not more than 1 weight percent, based on the total weight of the feed stream introduced into the liquification system 40, or it can be in a range of from 0.1 to 10 weight percent, 0.5 to 8 weight percent, or 1 to 5 weight percent, based on the total weight of the feed stream introduced into the liquification system.

As discussed above, one or more of the methods of liquefying the waste plastic stream in the liquification system can involve a heating/melting step, which may be carried out in a melt tank system to thereby form a molten feed, such as a molten waste plastic. During this step, at least a portion of the plastic may be heated above its melt temperature and/or glass transition temperature to thereby form a molten waste plastic. As used herein, a “molten feed” refers to a substantially liquid feed that contains at least one component that is in substantially liquid form and has been heated above its melt temperature and/or glass transition temperature. Similarly, as used herein, a “molten waste plastic” refers to a waste plastic in substantially liquid form that has been heated above its melt temperature and/or glass transition temperature.

In an embodiment or in combination with any embodiment mentioned herein, the liquified plastic stream exiting the liquification system can have a viscosity of less than 3,000, less than 2,500, less than 2,000, less than 1,500, less than 1,000, less than 800, less than 750, less than 700, less than 650, less than 600, less than 550, less than 500, less than 450, less than 400, less than 350, less than 300, less than 250, less than 150, less than 100, less than 75, less than 50, less than 25, less than 10, less than 5, or less than 1 cP, as measured using a Brookfield R/S rheometer with V80-40 vane spindle. Additionally, or in the alternative, the viscosity of the liquified plastic stream exiting the liquification zone is not more than 95, not more than 90, not more than 75, not more than 50, not more than 25, not more than 10, not more than 5, or not more than 1 percent of the viscosity of the PO-enriched stream introduced into the liquification zone.

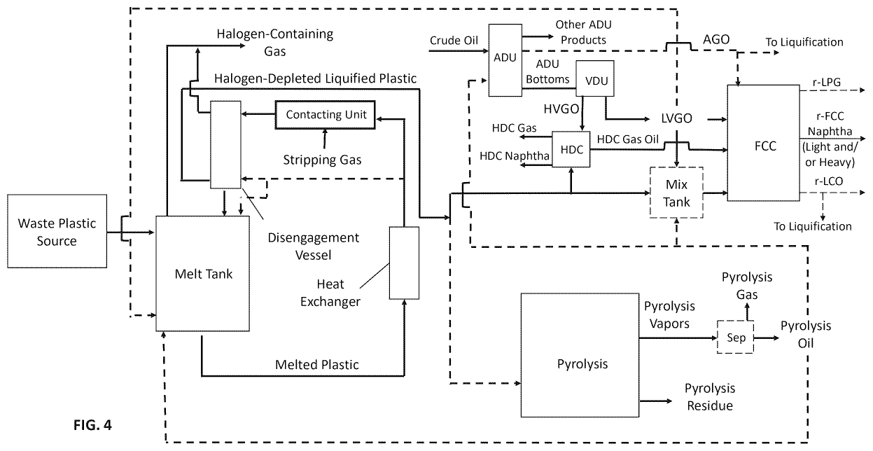

Referring now to FIG. 4, the basic components in a liquification/dehalogenation system located upstream from a pyrolysis facility and refinery processes are shown. It should be understood that FIG. 4 depicts one exemplary embodiment of a liquification/dehalogenation system. Certain features depicted in FIG. 4 may be omitted and/or additional features described elsewhere herein may be added to the system depicted in FIG. 4.

As shown in FIG. 4, a waste plastic feed, such as the PO-enriched waste plastic stream, may be derived from a waste plastic source, such as a preprocessing facility. The waste plastic feed may then be introduced into the liquification system, which FIG. 4 depicts as a melt tank system containing at least one melt tank. While in the melt tank system, at least a portion of the plastic feed may be heated above its melting temperature and/or glass transition temperature to thereby form a liquefied (i.e., molten) waste plastic.

In an embodiment or in combination with any embodiment mentioned herein, the liquification system may further include at least one external heat exchanger, at least one contacting unit (e.g., stripping column, in line-mixer, etc.), and/or at least one disengagement vessel. These various exemplary components and their functionality in the liquification system are discussed in greater detail below.

In an embodiment or in combination with any embodiment mentioned herein, the liquification system includes a melt tank and a heater. The melt tank receives the waste plastic feed, and the heater heats the waste plastic.

In an embodiment or in combination with any embodiment mentioned herein, the melt tank can include one or more continuously stirred tanks. When one or more rheology modification agents (e.g., solvents, depolymerization agents, plasticizers, and blending agents) are used in the liquification system, such rheology modification agents can be added to and/or mixed with the waste plastic in or prior to the melt tank.

In an embodiment or in combination with any embodiment mentioned herein, the heater of the liquification system can take the form of internal heat exchange coils located in the melt tank, a jacketing on the outside of the melt tank, a heat tracing on the outside of the melt tank, and/or electrical heating elements on the outside of the melt tank. Additionally, or alternatively, as shown in FIG. 4, the heater of the liquification system can include an external heat exchanger that receives a stream of liquified plastic from the melt tank, heats it, and returns at least a portion of the heated liquified plastic stream to the melt tank.

The external heat exchanger can comprise any conventional heat exchanger known and used in the art. In an embodiment or in combination with any embodiment mentioned herein, the external heat exchanger can comprise a single pass or multiple pass vertical heat exchanger. As shown in FIG. 4, the external heat exchanger receives liquified plastic from the melt tank and heats it up for further processing. Additionally, when an external heat exchanger is used to provide heat for the liquification system, a circulation loop can be employed to continuously add heat to the waste plastic. The circulation loop can include the melt tank, the external heat exchanger, conduits connecting the melt tank and the external heat exchanger, and a pump for circulating liquified waste plastic in the circulation loop. When a circulation loop is employed, the liquified plastic material produced can be continuously withdrawn from the liquification system as a fraction of the circulating stream.

Although FIG. 4 depicts the liquification system comprising only a single melt tank, a single heat exchanger, a single contacting unit, and a single disengagement vessel, it is within the scope of the present application that the liquification system may comprise a plurality of melt tanks, a plurality of external heat exchangers, a plurality of contacting units, and/or a plurality of disengagement vessels.

In an embodiment or in combination with any embodiment mentioned herein, dehalogenation of the liquefied plastic stream can be promoted by sparging a stripping gas (e.g., steam) into the liquified plastic material when the liquefied plastic is introduced and present in the contacting unit. The stripping gas can comprise, for example, nitrogen, steam, methane, carbon monoxide, carbon dioxide, and/or hydrogen. In particular embodiments, the stripping gas can comprise steam.

As shown in FIG. 4, in an embodiment or in combination with any embodiment mentioned herein, a contacting unit, and a disengagement vessel can be provided in the circulation loop downstream of the external heat exchanger and upstream of the melt tank. As shown in FIG. 4, the contacting unit can receive the heated liquified plastic from the external heat exchanger and provide for the sparging of a stripping gas stream into the liquified plastic. In certain embodiments, sparging of a stripping gas into the liquified plastic can create a two-phase medium in the contacting unit. The two-phase medium formed in the contacting unit can then be flowed (e.g., by gravity) through the disengagement vessel, where a halogen-enriched gaseous phase is disengaged from a halogen-depleted liquid phase. Alternatively, as shown in FIG. 4, a portion of the heated liquefied plastic from the external heat exchanger may bypass the contacting unit and be introduced directly into the disengagement vessel.

In an embodiment or in combination with any embodiment mentioned herein, a first portion of the halogen-depleted liquid phase discharged from an outlet of the disengagement vessel can be returned to the melt tank, while a second portion of the halogen-depleted liquid phase can be discharged from the liquification system as the dehalogenated, liquified plastic stream. The disengaged halogen-enriched gaseous stream can be removed from the liquification system for further processing and/or disposal.

In an embodiment or in combination with any embodiment mentioned herein, the interior space of the melt tank, where the plastic is heated, can be maintained at a temperature of at least 200, at least 210, at least 220, at least 230, at least 240, at least 250, at least 260, at least 270, at least 280, at least 290, at least 300, at least 310, at least 320, at least 330, at least 340, at least 350, at least 360, at least 370, at least 380, at least 390, or at least 400° C. Additionally, or in the alternative, the interior space of the melt tank may be maintained at a temperature of not more than 500, not more than 475, not more than 450, not more than 425, not more than 400, not more than 390, not more than 380, not more than 370, not more than 365, not more than 360, not more than 355, not more than 350, or not more than 345° C. Generally, in one or more embodiments, the interior space of the melt tank may be maintained at a temperature ranging from 200 to 500° C., 240 to 425° C., 280 to 380° C., or 320 to 350°C.

In an embodiment or in combination with any embodiment mentioned herein, the plastic fed into the melt tank may have a residence time in the melt tank of at least 1, at least 5, at least 10, at least 20, at least 30, at least 40, at least 50, or at least 60 minutes and/or not more than 10, not more than 9, not more than 8, not more than 7, not more than 6, not more than 5, not more than 4, or not more than 3 hours. Generally, in one or more embodiments, the plastic fed into the melt tank may have a residence time in the melt tank in the range of 1 minute to 10 hours, 30 minutes to 6 hours, or 60 minutes to 4 hours.

In an embodiment or in combination with any embodiment mentioned herein, the pressure within the melt tank may be maintained at a range from an absolute vacuum to a positive pressure (e.g., 50 psig).

As noted above, the external heat exchanger provides additional heating and further heats the liquefied plastic from the melt tank. In an embodiment or in combination with any embodiment mentioned herein, the liquefied plastic fed into the external heat exchanger may have a residence time in the heat exchanger of at least 1, at least 5, at least 10, at least 20, at least 50 or at least 100 seconds, and/or not more than 30, not more than 25, not more than 20, not more than 15, or not more than 10 minutes. Generally, in one or more embodiments, at least 50, at least 75, at least 90, at least 95, or at least 99 percent, or substantially all of the heat used to form the molten waste plastic in the melt tank is provided by the external heat exchanger.

Turning back to FIG. 4, at least a portion of the molten plastic from the external heat exchanger may be introduced into a contacting unit configured to sparge a stripping gas stream into the liquified waste plastic to thereby form a multi-phase mixture, which may comprise a gaseous phase and a liquid phase (e.g., a two-phase mixture). Generally, in one or more embodiments, the contacting unit comprises one or more sparger tubes comprising a plurality of apertures that are configured to distribute the stripping gas into the molten waste plastic. In an embodiment or in combination with any embodiment mentioned herein, the liquefied plastic may have a residence time in the contacting unit of at least 1 second, at least 3 seconds, at least 5 seconds, at least 10 seconds, at least 30 seconds, at least 1 minute, at least 5 minutes, at least 10 minutes, at least 15 minutes, or at least 30 minutes and/or not more than 60 minutes, not more than 30 minutes, not more than 10 minutes, not more than 5 minutes, or not more than 1 minute. The residence time in the contacting unit is largely affected by the position and size of the contacting unit. Generally, while in the contacting unit, the stripping gas may be introduced into the molten waste plastic at a stripping gas to molten waste plastic ratio of at least 0.01:1, at least 0.05:1, or at least 0.1:1 and/or not more than 3:1, not more than 2:1, not more than 1:1, or not more than 0.9:1, on a volume basis.

Furthermore, in an embodiment or in combination with any embodiment mentioned herein, the disengagement vessel can be configured to receive the multi-phase mixture from the contacting unit and disengage the gaseous phase from the liquid phase of the multi-phase mixture to thereby provide a halogen-enriched gaseous material and a halogen-depleted molten waste plastic. The disengagement vessel may comprise a gravity-flow, multi-level, tray-containing vessel. Generally, in one or more embodiments, the multi-phase mixture may have a residence time (as calculated by the volume of the disengagement vessel divided by the multiphase volumetric flow entering of the vessel) in the disengagement vessel of at least 10 seconds, at least 30 seconds, at least 1 minute, at least 5 minutes, at least 10 minutes, at least 15 minutes, or at least 30 minutes and/or not more than 2 hours, not more than 60 minutes, not more than 30 minutes, or not more than 10 minutes.

As shown in FIG. 4, at least a portion of the halogen-depleted molten waste plastic from the disengagement vessel may be reintroduced to the melt tank for further liquefying and/or at least a portion of the halogen-depleted molten waste plastic may be removed from the liquification system at or near an outlet of the disengagement vessel for further processing in a downstream facility, such as in a pyrolysis reactor at a pyrolysis facility and/or an FCC unit at a refinery facility.

In an embodiment or in combination with any embodiment mentioned herein, the recirculated and heated molten plastic from the disengagement vessel (and the circulation loop) may be used to provide heat in the melt tank and, therefore, may assist in the heating and melting of the solid waste plastic introduced in the melt tank. Generally, in one or more embodiments, the ratio of the halogen-depleted molten waste plastic returned to the melt tank to the halogen-depleted molten waste plastic removed from the liquification system is at least 0.1:1, at least 0.2:1, at least 0.5:1, or at least 0.8:1 and/or not more than 50:1, not more than 40:1, not more than 30:1, not more than 20:1, not more than 10:1, not more than 5:1, or not more than 1:1. Generally, in one or more embodiments, the ratio of the halogen-depleted molten waste plastic returned to the melt tank to the halogen-depleted molten waste plastic removed from the liquification system is in the range of 0.1:1 to 50:1, 0.5:1 to 40:1, or 1:1 to 10:1.

In an embodiment or in combination with any embodiment mentioned herein, at least 50, at least 75, at least 90, at least 95, or at least 99 percent, or substantially all of the heat used to form the molten waste plastic in the melt tank is provided by the heated waste plastic returned to the melt tank from the external heat exchanger.

In an embodiment or in combination with any embodiment mentioned herein, not more than 50, not more than 25, not more than 10, not more than 5 percent, or substantially none of the heat used to form the molten waste plastic in the melt tank is provided via indirect heat transfer through surfaces of or within the melt tank. In certain embodiments, the melt tank may comprise no internal heating elements or external heat jacketing. Thus, in such embodiments, the heat necessary to form the molten waste plastic may be derived solely from the external heat exchanger and/or the heated molten waste plastic returned to the melt tank from the circulation loop. In an embodiment or in combination with any embodiment mentioned herein, at least a portion of the pyrolysis vapors from the pyrolysis facility may be routed (not shown) to the external heat exchanger so as to recycle the heat from these streams back into the circulation loop of the liquification system.

In an embodiment or in combination with any embodiment mentioned herein, the halogen-depleted molten waste plastic is produced by the liquification system at a rate of at least 2,000, at least 10,000, at least 25,000, at least 50,000, or at least 100,000 pounds per hour.

In an embodiment or in combination with any embodiment mentioned herein, the melt tank configuration may not contain an external heat exchanger. Rather, in such embodiments, an internal heating system (not shown) is provided in the melt tank to provide the heat necessary to form the molten waste plastic. In an embodiment or in combination with any embodiment mentioned herein, this internal heating system can take the form of one or more internal heat exchange coils located in the melt tank. The molten plastic from the melt tank may be transferred via the circulation loop to the contacting unit to form a two-phase mixture, which may then be separated in the disengagement vessel. The resulting halogen-depleted molten plastic may be either reintroduced into the melt tank (for additional treatment and/or to provide supplemental heating) and/or sent downstream for further processing in the pyrolysis reactor and/or a refinery process (e.g., FCC unit).

In an embodiment or in combination with any embodiment mentioned herein, the melt tank configuration may not utilize a disengagement vessel. Rather, in such embodiments, the melt tank system may comprise at least two melt tank circulation loops (not shown) placed in series, wherein each melt tank circulation loop comprises a melt tank, an external heat exchanger, and a contacting unit. The halogen-depleted molten plastic may be formed by sequential treatment in each of these melt tank circulation loops. The molten plastic from the first melt tank may be transferred via the circulation loop to the first heat exchanger to form a heated molten plastic. Afterwards, the heated molten plastic may be sent to the contacting unit to form a two-phase mixture. Subsequently, this two-phase mixture may then be reintroduced into the melt tank, where it may be separated into a halogen-enriched gaseous byproduct stream (and removed from the system) and a halogen-depleted molten liquid stream. The resulting halogen-depleted molten plastic may be either recirculated in the first circulation loop and/or sent for additional processing in the second melt tank circulation loop. After sufficient treatment in the second melt tank circulation loop, the resulting halogen-depleted molten waste plastic may be sent downstream for further processing in the pyrolysis reactor and/or refinery process (e.g., FCC unit). Additionally, it is feasible for the system to contain more melt tank circulation loops. For example, the liquification system may comprise at least 3, at least 4, at least 5, at least 6, at least 7, or at least 8 melt tank circulation loops either in parallel and/or series.

In an embodiment or in combination with any embodiment mentioned herein, the melt tank configuration may not utilize a disengagement vessel or an external contacting unit. Rather, such embodiments, the melt tank configuration may comprise at least two melt tank circulation loops (not shown) placed in series, wherein each melt tank circulation loop comprises a melt tank and an external heat exchanger. Furthermore, each of the melt tanks may comprise an internal sparger for introducing a stripping gas stream into the molten waste plastic within the melt tank. The halogen-depleted molten plastic may be formed by sequential treatment in each of these melt tank circulation loops. The molten plastic from the first melt tank may be transferred via the circulation loop to the first heat exchanger to form a heated molten plastic, which may then be returned to the first melt tank. While in the melt tank, the molten waste plastic may be sparged with a stripping gas stream from the internal sparger located in the melt tank in order to form a two-phase mixture. Subsequently, this two-phase mixture may be separated into a halogen-enriched gaseous byproduct stream (and removed from the system) and a halogen-depleted molten liquid. The resulting halogen-depleted molten plastic may be either recirculated in the first circulation loop and/or sent for additional processing in the second melt tank circulation loop. After sufficient treatment in the second melt tank circulation loop, the resulting halogen-depleted molten waste plastic may be sent downstream via conduit for further processing in the pyrolysis reactor and/or refinery process (e.g., FCC unit). Additionally, it is feasible for the system to contain more melt tank circulation loops. For example, the liquification system may comprise at least 3, at least 4, at least 5, at least 6, at least 7, or at least 8 melt tank circulation loops either in parallel and/or series.

In an embodiment or in combination with any embodiment mentioned herein, the melt tank configuration may not utilize a disengagement vessel, an external heat exchanger, or an external contacting unit. Rather, in such embodiments, two melt tanks may be placed in series, wherein each melt tank comprises an internal heating system and an internal sparger for introducing a stripping gas stream into the molten waste plastic within the melt tank (not shown). The halogen-depleted molten plastic may be formed by sequential treatment in each of these melt tanks. While in each of the melt tanks, the molten waste plastic may be sparged with a stripping gas stream from the internal sparger located in the melt tank in order to form a two-phase mixture. Subsequently, this two-phase mixture may be separated into a halogen-enriched gaseous byproduct stream (and removed from the system) and a halogen-depleted molten liquid. After sufficient treatment in the second melt tank, the resulting halogen-depleted molten waste plastic may be sent downstream for further processing in the pyrolysis reactor and/or refinery process (e.g., FCC unit). Additionally, it is feasible for the system to contain more melt tanks in series. For example, the liquification system may comprise at least 3, at least 4, at least 5, at least 6, at least 7, or at least 8 melt tank circulation loops either in parallel and/or series.

In an embodiment or in combination with any embodiment mentioned herein, the melt tank configuration may not utilize a disengagement vessel, a contacting unit, or a sparger. Rather, in such embodiments, the melt tank configuration may comprise at least four melt tank circulation loops placed in series, wherein each melt tank circulation loop comprises a melt tank and an external heat exchanger. The halogen-depleted molten plastic may be formed by sequential treatment in each of these melt tank circulation loops. For example, the molten plastic from the first melt tank may be transferred via the circulation loop to the first heat exchanger to form a heated molten plastic, which may then be returned to the first melt tank. In each melt tank circulation loop, a halogen-enriched gaseous byproduct stream may be formed (and removed from the system) and separated from the molten plastic. The resulting halogen-depleted molten plastic may be either recirculated in the circulation loop and/or sent for additional processing in the next melt tank circulation loop. After sufficient treatment in the fourth melt tank circulation loop, the resulting halogen-depleted molten waste plastic may be sent downstream for further processing in the pyrolysis reactor and/or refinery process (e.g., FCC unit). Additionally, it is feasible for the system to contain more melt tank circulation loops. For example, the liquification system may comprise at least 5, at least 6, at least 7, or at least 8 melt tank circulation loops either in parallel and/or series.

As described above, while in the melt tank system, at least a portion of the halogens present in the plastic feed stream can be removed from the plastic feed stream. More particularly, in one or more embodiments, the liquification system can also contain equipment for removing halogens from the waste plastic feed stream. For example, when the waste plastic is heated in the melt tank system, halogen enriched gases can evolve. The evolved halogen-enriched gases may be disengaged from the resulting liquified plastic material, which results in a liquefied (i.e., molten) plastic stream with a reduced halogen content. As shown in FIG. 4, the resulting halogen-depleted liquefied waste plastic may then be introduced into downstream processing facilities, such as a pyrolysis reactor in a pyrolysis facility and/or a refinery unit (e.g., FCC unit), while the halogen-enriched gas may be removed from the system.

As also shown in FIG. 4, pyrolysis vapors from the downstream pyrolysis facility may be separated (as discussed below) into a pyrolysis gas stream and a pyrolysis oil stream, while the pyrolysis heavy residue may be removed from the pyrolysis system for other downstream uses. Furthermore, in an embodiment or in combination with any embodiment mentioned herein, at least a portion of the pyrolysis oil stream may be recycled back to the melt tank system in order to provide pyrolysis oil to the melt tank system, where the pyrolysis oil may function as a dissolution or solvation solvent, as discussed above, as well as optionally as a heat-carrier (providing heating to liquification). Additionally, or alternatively, another dissolution solvent may be added to the melt tank system, as discussed above. In an embodiment or in combination with any embodiment mentioned herein, at least 1, at least 5, at least 10, at least 15, at least 20, at least 25, at least 50, at least 75, at least 90, or at least 99 percent of the pyrolysis oil stream may be recycled back to the liquification system, such as the melt tank system, for use as a dissolution solvent, as well as optionally as a heat-carrier. In certain embodiments, all of the pyrolysis oil stream may be recycled back to the liquification system.

In an embodiment or in combination with any embodiment mentioned herein, the liquified molten plastic stream exiting the liquification system, such as the melt tank system, can have a viscosity of less than 3,000, less than 2,500, less than 2,000, less than 1,500, less than 1,000, less than 800, less than 750, less than 700, less than 650, less than 600, less than 550, less than 500, less than 450, less than 400, less than 350, less than 300, less than 250, less than 150, less than 100, less than 75, less than 50, less than 40, less than 30, less than 25, less than 20, less than 10, less than 5, less than 4, less than 3, less than 2, or less than 1 cP and/or at least 0.1, at least 0.2, or at least 0.5 cP, as measured using a Brookfield R/S rheometer with V80-40 vane spindle. For example, the liquified molten plastic stream exiting the liquification system, such as the melt tank system, can have a viscosity of 0.1 to 3,000 cP, 0.1 to 800 cP, 0.1 to 500 cP, 0.1 to 250 cP, 0.1 to 75 cP, 0.1 to 50 cP, 0.1 to 10 cP, 0.1 to 5 cP, or 0.1 to 1 cP, as measured using a Brookfield R/S rheometer with V80-40 vane spindle.

In an embodiment or in combination with any embodiment mentioned herein, the viscosity of the liquified plastic stream exiting the liquification system, such as the melt tank system, is not more than 95, not more than 90, not more than 75, not more than 50, not more than 25, not more than 10, not more than 5, or not more than 1 percent of the viscosity of the waste plastic stream introduced into the liquification system.

In an embodiment or in combination with any embodiment mentioned herein, the halogen-depleted molten waste plastic exiting the liquification system, such as the melt tank system, can have a halogen content of less than 500, less than 400, less than 300, less than 200, less than 100, less than 50, less than 10, less than 5, less than 2, less than 1, less than 0.5, or less than 0.1 ppmw.

In an embodiment or in combination with any embodiment mentioned herein, the halogen content of the liquified plastic stream exiting the liquification system, such as the melt tank system, is not more than 95, not more than 90, not more than 75, not more than 50, not more than 25, not more than 10, or not more than 5 percent by weight of the halogen content of the waste plastic stream introduced into the liquification system.

In an embodiment or in combination with any embodiment mentioned herein, the liquified (or reduced viscosity) plastic stream withdrawn from the liquification system, such as the melt tank system, can include at least 1, at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, or at least 95 weight percent and/or not more than 95, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, not more than 10, not more than 5, not more than 2, or not more than 1 weight percent of polyolefins, based on the total weight of the stream, or the amount of polyolefins can be in the range of from 1 to 95 weight percent, 5 to 90 weight percent, or 10 to 85 weight percent, based on the total weight of the stream.

As shown in FIGS. 3 and 4, the liquified waste plastic may be fed to a refinery process, such as an FCC unit and/or hydrocracker unit, as described herein, and/or to a pyrolysis facility. In an embodiment or in combination with any embodiment mentioned herein, the liquefied waste plastic stream from the liquification system may be selectively routed and proportioned to the refinery process (e.g., FCC unit, hydrocracker) and pyrolysis facility. For example, at least 10, at least 20, at least 30, at least 40, at least 50, at least 60, at least 70, at least 80, or at least 90 percent and/or not more than 99, not more than 95, or not more than 92 percent of the liquefied waste plastic stream can be directed and sent to the refinery process (e.g., FCC unit, hydrocracker). In certain embodiments, 10 to 99, 20 to 99, 40 to 95, or 70 to 95 percent of the liquefied waste plastic stream can be directed and sent to the refinery process.

Additionally, or in the alternative, in an embodiment or in combination with any embodiment mentioned herein, at least 1, at least 2, at least 3, at least 4, at least 5, at least 10, or at least 15 percent and/or not more than 90, not more than 50, not more than 30, or not more than 20 percent of the liquefied waste plastic stream can be directed and sent to the pyrolysis facility. In certain embodiments, 1 to 90, 1 to 50, 1 to 30, or 1 to 20 percent of the liquefied waste plastic stream can be directed and sent to the pyrolysis facility. In such embodiments, the proportioned liquefied waste plastic stream can be converted into pyrolysis oil in the pyrolysis facility, which may then be recycled back to the liquification system, as discussed above.

Turning now to FIG. 2, a schematic diagram of the main steps/zones of a pyrolysis facility as shown in FIG. 1 are provided. As shown in FIG. 2, at least a portion of the liquified waste plastic stream (which may be predominantly PO waste plastic) can be introduced into a pyrolysis facility and pyrolyzed in at least one pyrolysis reactor. The pyrolysis reaction involves chemical and thermal decomposition of the waste plastic introduced into the reactor. Although all pyrolysis may be generally characterized by a reaction environment that is substantially free of molecular oxygen, pyrolysis processes may be further defined by other parameters such as the pyrolysis reaction temperature within the reactor, the residence time in the pyrolysis reactor, the reactor type, the pressure within the pyrolysis reactor, and the presence or absence of pyrolysis catalysts.

The feed to the pyrolysis reactor can comprise, consists essentially of, or consists of waste plastic, such as the liquified waste plastic described herein, and the feed stream can have a number average molecular weight (Mn) of at least 3000, at least 4000, at least 5000, or at least 6000 g/mole. If the feed to the pyrolysis reactor contains a mixture of components, the Mn of the pyrolysis feed is the average Mn of all feed components, based on the weight of the individual feed components. The waste plastic in the feed to the pyrolysis reactor can include post-consumer waste plastic, post-industrial waste plastic, or combinations thereof. In certain embodiments, the feed to the pyrolysis reactor comprises less than 5, less than 2, less than 1, less than 0.5, or about 0.0 weight percent coal and/or biomass (e.g., lignocellulosic waste, switchgrass, fats and oils derived from animals, fats and oils derived from plants, etc.). The feed to the pyrolysis reaction can also comprise less than 5, less than 2, less than 1, or less than 0.5, or about 0.0 weight percent of a co-feed stream, including steam and/or sulfur-containing co-feed streams. In other cases, steam fed to the pyrolysis reactor can be present in amounts of up to 50 weight percent.

The pyrolysis reaction can involve heating and converting the waste plastic feedstock in an atmosphere that is substantially free of molecular oxygen or in an atmosphere that contains less molecular oxygen relative to ambient air. For example, the atmosphere within the pyrolysis reactor may comprise not more than 5, not more than 4, not more than 3, not more than 2, not more than 1, or not more than 0.5 weight percent of molecular oxygen.

The pyrolysis reaction in the reactor can be thermal pyrolysis, which is carried out in the absence of a catalyst, or catalytic pyrolysis, which is carried out in the presence of a catalyst. When a catalyst is used, the catalyst can be homogenous or heterogeneous and may include, for example, oxides, certain types of zeolites, and other mesostructured catalysts.

The pyrolysis reactor may have any suitable design and can comprise a film reactor, a screw extruder, a tubular reactor, a stirred tank reactor, a riser reactor, a fixed bed reactor, a fluidized bed reactor, a rotary kiln, a vacuum reactor, a microwave reactor, or an autoclave. The reactor may also utilize a feed gas and/or lift gas for facilitating the introduction of the feed into the pyrolysis reactor. The feed gas and/or lift gas can comprise nitrogen and can comprise less than 5, less than 2, less than 1, or less than 0.5, or about 0.0 weight percent of steam and/or sulfur-containing compounds. The feed and/or lift can also include light hydrocarbons, such a methane, or hydrogen, and these gases may be used alone or in combination with steam.

As shown in FIG. 2, a stream of recycled content pyrolysis effluent (r-pyrolysis effluent) removed from the reactor can be separated in a separation zone to provide a recycled content pyrolysis vapor (r-pyrolysis vapor) stream and a recycled content pyrolysis residue (r-pyrolysis residue) stream. The r-pyrolysis vapor can include a range of hydrocarbon materials and may comprise both recycled content pyrolysis gas (r-pygas) and recycled content pyrolysis oil (r-pyoil). In some embodiments, the pyrolysis facility may include an additional separation zone, as shown in FIG. 2, to separate the r-pyoil and r-pygas into separate streams. In such embodiments, at least a portion of the r-pyoil may be recycled back for use in the liquification process, as described above, and/or at least a portion of the r-pyoil may be used as feedstock to a refinery atmospheric distillation unit or other refinery process, as described below. Alternatively, the entire stream of r-pyrolysis vapor may be withdrawn from the pyrolysis facility and routed to one or more downstream processing facilities.

The r-pyoil can include predominantly C5 to C22 hydrocarbon components, or it can include at least 55, at least 60, at least 65, at least 70, at least 75, or at least 80 weight percent of C5 to C22 hydrocarbon components, while the r-pygas can include predominantly C2 to C4 hydrocarbon components, or at least 30, at least 40, at least 45, at least 55, at least 60, at least 65, at least 70, at least 75, or at least 80 weight percent C2 to C4 hydrocarbon components. In some cases, the C2 to C4 components in the r-pygas can include at least 50, at least 55, at least 60, at least 65, at least 70, or at least 75 weight percent of alkanes and/or at least 40, at least 45, at least 50, at least 55, at least 60, at least 65, at least 70, or at least 75 weight percent of olefins, based on the amount of C2 to C4 hydrocarbon components in the stream.

The r-pyoil may also comprise one or more of the following (i) through (v): (i) less than 500 ppm, less than 450 ppm, less than 350 ppm, less than 250 ppm, less than 100 ppm, less than 75 ppm, less than 50 ppm, less than 25 ppm, or less than 10 ppm sulfur; (ii) less than 300 ppm, less than 150 ppm, less than 100 ppm, less than 50 ppm, less than 25 ppm, less than 10 ppm, or less than 5 ppm chlorine; (iii) less than 500 ppm, less than 250 ppm, less than 100 ppm, less than 75 ppm, less than 50 ppm, less than 30 ppm, or less than 20 ppm water; (iv) less than 500 ppb, less than 250 ppb, less than 100 ppb, less than 50 ppb, less than 25 ppb, less than 10 ppb, less than 5 ppb, or less than 2 ppb arsenic; and/or (v) less than 1500 ppm, less than 1000 ppm, less than 500 ppm, less than 250 ppm, less than 100 ppm, less than 75 ppm, less than 50 ppm, less than 30 ppm, or less than 20 ppm nitrogen.

As also illustrated in FIG. 1, at least a portion of the r-pyoil, r-pygas, and/or r-pyrolysis vapor can be introduced into a refinery, wherein one or more of these streams can undergo one or more processing steps to provide at least a stream of recycled content naphtha (r-naphtha), as well as one or more other recycled content hydrocarbon streams. Examples of suitable processing steps include, but are not limited to, distillation or other separation steps as well as chemical processing such as thermal and/or catalytic cracking or other reactions such as reforming and isomerization.

Turning again to FIG. 4, a schematic diagram of the main steps or zones in a refining facility, or refinery, suitable for processing at least one hydrocarbon stream including recycled content derived from waste plastic is provided. It should be understood that other processing steps may exist and/or other recycled content hydrocarbon streams may be produced in the refinery shown in FIG. 4. The steps, zones, and process streams illustrated in FIG. 4 are provided for simplicity and not intended to exclude other steps, zones, or process streams not shown.

As shown in FIG. 4, a stream of crude oil may be introduced into an atmospheric distillation unit (ADU) and separated in at least one distillation column to provide several hydrocarbon fractions having specified cut points. As used herein, the term “cut point” refers to the range of temperatures over which a specified petroleum fraction boils. The lower value in a boiling point range is the initial boiling point (IBP) temperature for that specified fraction and the higher value is the end point (EP) temperature for that specified fraction. Cut points are often used to identify specific streams or fractions within and/or produced by the refinery.

In addition to a stream of crude oil, the refinery shown in FIG. 4 can also process a stream of r-pyoil introduced into the ADU. In one embodiment or in combination with any embodiments mentioned herein, the r-pyoil may originate from a pyrolysis as discussed previously with respect to FIG. 2. The r-pyoil introduced into the ADU can comprise less than 50, less than 40, less than 30, less than 20, less than 10, less than 9, less than 8, less than 7, less than 6, less than 5, less than 4, less than 3, less than 2, or less than 1 weight percent of the total feed to the at least one distillation column.

The ratio of the mass flow rate of r-pyoil introduced into the ADU to the mass flow rate of petroleum (crude) oil introduced into the ADU can be at least 1:1000, at least 1:750, at least 1:500, at least 1:250, at least 1:100, at least 1:50, at least 1:25, or at least 1:10 and/or not more than 1:1, not more than 1:2, not more than 1:5, or not more than 1:10. The amount of r-pyoil introduced into the ADU can be at least 0.1, at least 0.25, at least 0.75, at least 1, at least 5, at least 10, at least 15, at least 20 weight percent and/or not more than 75, not more than 65, not more than 60, not more than 50, or not more than 45 weight percent of the total feed to the at least one distillation column.

Alternatively, when the r-pyoil is not introduced into the ADU, the feed to the atmospheric distillation column may include less than 1000, less than 500, less than 250, less than 100, less than 75, less than 50, less than 30, or less than 20 parts per million (ppm) by weight of r-pyoil, or it can include no r-pyoil. Additionally, or in the alternative, a stream of recycled content pyrolysis vapor (r-pyrolysis vapor) and/or a stream of recycled content pyrolysis residue (r-pyrolysis residue) could be introduced into the ADU (not shown), alone or in combination with one another and/or r-pyoil and may be further separated as described herein.

The ADU separates feed stock (e.g., crude oil, r-pyoil) into multiple hydrocarbon streams, or fractions. These fractions may include, but are not limited to, light gas, naphtha, distillate, gas oil (called atmospheric gas oil, or AGO), and residue or resid (or ADU bottoms). While FIG. 4 illustrates only the AGO and ADU Bottoms streams, it should be understood that one or more of the other ADU products listed above may also be produced in accordance with the present technology. When the ADU processes at least one recycled content feedstock, such as r-pyoil, each of the products formed by the ADU may include recycled content. Thus, the ADU may provide recycled content light gas (r-light gas), recycled content light naphtha (r-naphtha), recycled content heavy naphtha (r-heavy naphtha), recycled content distillate (r-distillate), recycled content atmospheric gas oil (r-AGO), and recycled content atmospheric resid (r-atmospheric resid). The mass flow rate of each stream, as well as its mass or volume in proportion to other streams, depends on the operation of the ADU as well as the properties of the feedstocks being processed. As mentioned previously, other hydrocarbon streams can be produced from the ADU, but are not shown here for simplicity.

The ADU comprises at least one distillation column operated at or near atmospheric pressure. Additionally, the ADU may include other equipment such as desalters, side strippers, and reflux drums/accumulators, as well as various pumps, heat exchangers, and other auxiliary equipment needed to operate the unit.

As shown in FIG. 4, the heaviest stream withdrawn from the ADU is a stream of recycled content atmospheric resid (r-atmospheric resid) or ADU bottoms. In some cases, the r-atmospheric resid may be sent directly to a gas oil cracker such as those described below, while in other cases, it may be introduced into a vacuum distillation unit (VDU), as depicted in FIG. 4. In the VDU, further separation of various hydrocarbon fractions can be performed in a vacuum distillation column operated at pressures below atmospheric pressure. For example, in one embodiment or in combination with any embodiments mentioned herein, the overhead pressure of the vacuum distillation column can be less than 100, less than 75, less than 50, less than 40, or less than 10 mm Hg. Distilling the r-atmospheric resid at low pressure permits further recovery of lighter hydrocarbon components without cracking. The VDU provides product streams similar to the ADU, and when it processes a recycled content feedstock, provides recycled content products. Examples of such products include, but are not limited to, recycled content light vacuum gas oil (r-LVGO), recycled content heavy vacuum gas oil (r-HVGO), and recycled content vacuum resid (r-vacuum resid).

In one embodiment or in combination with any embodiments mentioned herein, at least a portion of one or more of the heavier hydrocarbon fractions (such as AGO, LVGO, HVGO, bottoms, etc.) from the ADU and/or VDU can be sent to a gas oil cracker. Such heavier hydrocarbon fractions can have a median boiling point (T50) greater than 375, greater than 400, greater than 500, greater than 600, greater than 650, greater than 700, greater than 800, or greater than 900° F. and/or not more than 1050, not more than 1000, not more than 950, not more than 900, not more than 850, not more than 800, not more than 700, not more than 650° F., or in the range of from 400° F. to 1050° F., from 500° F. to 1000° F., or 650° F. to 800° F., or it can be in the range of from 375 to 800° F., or 400° F. to 650° F. One or more of these heavy hydrocarbon fractions can comprise at least 85, at least 90, at least 95, at least 97, or at least 99 weight percent of C10, C15, C20, or C25 and heavier components. Examples of these streams as shown in FIG. 4 can include, but are not limited to, r-AGO, r-LVGO, and r-HVGO.

As mentioned previously, at least a portion of the r-atmospheric resid or bottoms may be introduced into the FCC, particularly when the refinery does not include a VDU. However, as shown in FIG. 4, when the refinery has a VDU, at least a portion of r-HVGO may be introduced into the hydrocracker (HDC). The r-LVGO can be fed to the FCC along with at least a portion of the r-AGO. Depending on the specific configuration of the refinery, other processing schemes are possible that fall within the scope of the present technology. The r-LVGO may or may not be process in a hydrotreater prior to entering the FCC or other gas oil cracker.

As described above, a waste plastic stream, and particularly a liquified waste plastic stream may be fed to a gas oil cracker, either alone or in combination with one or more refinery streams (e.g., r-AGO, r-LVGO, and r-HVGO) described herein. The liquified waste plastic may be fed individually and separately from the one or more refinery streams, or the liquified waste plastic may be combined with one or more of the refinery streams to form a feedstock before being introduced to the gas oil cracker.

The gas oil cracker can be any processing unit or zone that reduces the average molecular weight of a heavy hydrocarbon feedstock to provide one or more lighter hydrocarbon products (e.g., naphtha, light gas, etc.) via thermal and/or catalytic cracking. Gas oil crackers may be operated at temperatures of at least 350° F., at least 400° F., at least 450° F., at least 500° F., at least 550° F., or at least 600° F. and/or not more than 1200° F., not more than 1150° C., not more than 1100° F., not more than 1050° F., not more than 1000° F., not more than 900° F., or not more than 800° F. Gas oil crackers may be operated at or near atmospheric pressure (e.g., at a pressure of less than 5 psig, less than 2 psig, or 1 psig) or may be operated at elevated pressure (e.g., at a pressure of at least 5 psig, at least 10 psig, at least 25 psig, at least 50 psig, at least 100 psig, at least 250 psig, at least 500 psig, or at least 750 psig.) Additionally, the cracking in gas oil crackers may be carried with or without a catalyst, and it may or may not be conducted in the presence of hydrogen and/or steam. The gas oil cracker may include other equipment such as compressors, distillation columns, heat exchangers, and other equipment necessary to provide the cracked product streams. Examples of gas oil crackers illustrated in FIG. 4 include a fluidized catalytic cracker (FCC) and a hydrocracker (HDC).

Alternatively, or in addition, at least a portion of the cracking can be performed in the presence of hydrogen (e.g., in a hydrocracker as shown in FIG. 4) so that removal of components such as nitrogen-, chlorine-, and sulfur-containing components (and optionally metals), may be performed at the same time as the cracking reaction. When cracking and hydrogenation occur simultaneously, the saturation of olefinic hydrocarbons may also take place such that the amount of or olefins in the hydrocracker product stream is not more than 20, not more than 15, not more than 10, or not more than 5 weight percent. However, aromatics may remain such that the amount of aromatics in the stream withdrawn from the hydrocracker may be at least 1, at least 5, at least 10, at least 20, or at least 25 and/or not more than 50, not more than 40, or not more than 35 weight percent.

In one embodiment or in combination with any embodiments mentioned herein, one or more recycled content cracked hydrocarbon (r-cracked hydrocarbon) streams from the gas oil cracker may be further cracked in another gas oil cracker to provide additional recycled content cracked hydrocarbon (r-cracked hydrocarbon) streams. For example, as shown in FIG. 4, at least a portion of the r-LVGO from the VDU and/or the r-hydrocracker gas oil (r-HDC gas oil) from the hydrocracker may be introduced into the FCC. Other processing schemes are possible depending on the specific equipment and configuration of the refinery.

In one embodiment or in combination with any embodiments mentioned herein, a stream of r-pyoil and/or waste plastic can be directly introduced into one or more gas oil cracker units within the refinery. For example, as shown in FIG. 4, a stream of liquified waste plastic may be fed into an FCC, optionally after being mixed with r-pyoil. This stream may be co-fed with one or more other hydrocarbon streams, which may or may not include recycled content. For example, as shown in FIG. 4, the liquified waste plastic, and optional r-pyoil, fed to the FCC may be co-fed with r-AGO, r-LVGO, and/or r-HDC gas oil. One or more of the gas oil streams fed to the gas oil cracker may also include non-recycled content, particularly if no r-pyoil (or other r-pyrolysis stream) is fed to the ADU.

When waste plastic is fed to one of these gas oil crackers, the waste plastic may be liquified plastic waste formed by heating the waste plastic to at least partially melt it and/or by combining waste plastic with at least one solvent such as gas oil, r-gas oil, and/or r-pyoil, as described above. When combined with a solvent, the waste plastic may be dissolved or solvated, or it may be in the form of a slurry. In one embodiment or in combination with any embodiments mentioned herein, the waste plastic introduced into the refinery may not have been separated (e.g., it may be mixed plastic waste), while in other cases, it may have undergone at least one separation step so that the waste plastic comprises predominantly polyolefin (PO) waste plastic. In such cases, the waste plastic may include at least 55, at least 60, at least 65, at least 70, at least 75, at least 80, at least 85, at least 90, at least 95, or at least 99 weight percent of PO waste plastic, based on the total weight of the stream.

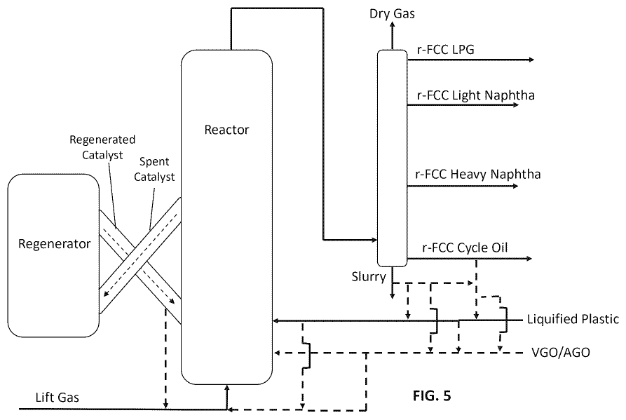

In one embodiment or in combination with any embodiments mentioned herein, the oil gas cracker may be a fluidized catalytic cracker (FCC) unit, such as the FCC unit generally depicted in FIG. 5. The FCC unit may generally comprise a reactor, a catalyst regenerator, and one or more separation vessels (e.g., fractionation tower) for separating the reactor effluent into distinct product streams. The feed to the FCC unit may be provided in one or more nozzles, which may introduce the same or different feedstocks, near the bottom portion of the reactor. As shown, the FCC unit feedstock may comprise liquified plastics (e.g., melted plastic), as described above, along with one or more refinery streams, such as gas oils (e.g., AGO, VGO) and cycle oil from the FCC separator bottoms. A lift gas is generally introduced to facilitate reaction of the feedstock in the reactor.

FIG. 5 illustrates possible points of introduction for the liquified plastic and other optional feedstocks to the FCC unit. As noted above, the FCC unit includes a reactor for cracking organic components fed into the unit via heat and in the presence of a circulating catalyst, a regenerator for regenerating the catalyst, and a main fractionator for separating the cracked products withdrawn from the reactor. The temperature of the reactor (as measured at the reactor exit) can be at least 450, at least 500, at least 510, at least 525, or at least 530° C. and/or not more than 680, not more than 650, not more than 625, not more than 600, not more than 575, not more than 545, not more than 540, or not more than 535° C., and the pressure can near atmospheric and typically less than 50 psig, less than 45 psig, or less than 40 psig. The regenerator can be operated at a higher temperature and pressure such as, for example, a temperature of at least 695, at least 700, at least 705, or at least 710° C. and/or not more than 745, not more than 740, not more than 735, not more than 730, not more than 700, not more than 680, not more than 650 or not more than 625° C., and a pressure of at least 20, at least 30, at least 40, at least 50, at least 75 psig. The catalyst used can be any suitable type and can comprise silica-alumina such as zeolites.

As shown in FIG. 5, the liquified plastic may be fed alone or may be combined with lift gas fed to the reactor of the FCC and the combined stream may subsequently contact the FCC feedstock and catalyst as it ascends the reactor/riser. As discussed previously, the FCC feedstock can comprise AGO (r-AGO), VGO (r-VGO), atmospheric resid (r-atmospheric resid), and/or vacuum resid (r-vacuum resid), as well as various gas oil (r-gas oil) streams from other gas oil crackers in the refinery (e.g., LVGO, HVGO, etc.). The lift gas can comprise, for example, steam and/or light hydrocarbons such as methane or even C2 and/or C3 hydrocarbons.

Spent catalyst disengages from the reaction product stream in a series of cyclones (not shown) and can be regenerated in the FCC regenerator. The recycled content FCC reactor effluent (r-FCC reactor effluent) withdrawn from the reactor can then be separated into various hydrocarbon cuts in the main fractionator, including, for example, recycled content LPG (r-LPG), recycled content FCC light naphtha (r-FCC light naphtha), recycled content FCC heavy naphtha (r-FCC heavy naphtha), and recycled content FCC cycle oil (r-FCC cycle oil). As shown in FIG. 5, at least a portion of the r-FCC cycle oil can optionally be combined with the FCC feedstock and/or liquified plastic and the combined stream may be introduced into the reactor for further cracking.

In one embodiment or in combination with any embodiment mentioned herein, at least a portion of the liquified plastic can be introduced directly into the FCC and can, in some cases, be introduced into the FCC reactor via separate inlet nozzles. Alternatively, or in addition, at least a portion of the liquified plastic can be combined and introduced into the FCC reactor in the same nozzle as one or more other FCC feedstock streams.

In one embodiment or in combination with any embodiments mentioned herein, at least a portion of a recycled content effluent (r-effluent) stream from the FCC and/or hydrocracker reaction vessels may be separated into several recycled content cracked hydrocarbon fractions, including a recycled content light gas (r-light gas or r-LPG) stream, a recycled content light naphtha stream (r-light naphtha), a recycled content heavy naphtha (r-heavy naphtha) stream, recycled content cracked distillate (r-cracked distillate) stream, and a recycled content gas oil (r-gas oil) stream.

In one embodiment or in combination with any embodiments mentioned herein, the r-LPG stream shown in FIG. 4 can comprise at least 55, at least 60, at least 65, at least 70, at least 75, at least 80, at least 85, at least 90, or at least 95 weight percent C3 and lighter or C2 and lighter components. The r-LPG stream may include at least 15, at least 20, at least 25, or at least 30 and/or not more than 50, not more than 45, not more than 40, or not more than 35 weight percent of C1 and lighter components and/or less than 20, less than 15, less than 10, less than 5, less than 2, less than 1, less than 0.5 or less than 0.1 weight percent of C4 and heavier components.

In one embodiment or in combination with any embodiment mentioned herein, at least a portion of the r-cracked effluent from a gas oil cracker can be separated into streams of r-light naphtha and r-heavy naphtha. As used herein, the term “light naphtha” refers to a specific portion of a naphtha cut in a refinery having a boiling point range between 90 and less than 190° F. As used herein, the term “heavy naphtha” refers to a specific portion of a naphtha cut in a refinery having a boiling point range between 190 and 380° F.

The r-light naphtha predominantly comprises C5 and C6 hydrocarbons and has a boiling point range of at least 90, at least 95, or at least 100° F. and/or not more than 190° F. and/or a T50 boiling point of at least 20, at least 25, or at least 30° F. and/or not more than 185, not more than 180, or not more than 175° F. The r-light naphtha can include olefins in an amount of from 0.001 to 25 weight percent, from 0.01 to 10 weight percent, or from 0.1 to 5 weight percent, and it can include alkanes in an amount of from 70 to 99 weight percent, from 80 to 95 weight percent, or at least 70, at least 80, at least 90, or at least 95 weight percent. The r-light naphtha may also comprise aromatic hydrocarbons in an amount of from 0.1 to 10 weight percent, from 0.5 to 5 weight percent, or less than 10 weight percent, less than 5 weight percent, less than 2 weight percent, or less than 1 weight percent aromatic hydrocarbon compounds. Additionally, the r-light naphtha can include from 0.1 to 10 weight percent, or 0.5 to 5 weight percent cycloparaffins and/or naphthenes, or less than 10 weight percent, less than 5 weight percent, less than 2 weight percent, or less than 1 weight percent of cycloparaffins and/or naphthenes.

The r-heavy naphtha predominantly comprises C6 and heavier, or C7 to C15 hydrocarbons and has a boiling point range of at least 190, at least 200, at least 210, at least 220, at least 230, at least 235, or at least 240° F. and/or less than 380, not more than 375, or not more than 370° F. The r-heavy naphtha can include at least 55, at least 65, at least 75, at least 85, or at least 90 weight percent of C6 and heavier or C7 and heavier components, and may include at least 20, at least 25, at least 30, at least 35, at least 40, or at least 45 weight percent and/or not more than 75, not more than 70, not more than 65, not more than 60, or not more than 55 weight percent of C6 to C10 components. At least a portion of the C6 to C10 components can include aromatics, such that, for example, the r-heavy naphtha stream includes an amount of C6 to C10, or C6 to C9, or C6 to C8 aromatics within one or more of the above ranges.

In one embodiment or in combination with any embodiments mentioned herein, at least one of the heavy hydrocarbon streams introduced into and/or at least one of the cracked hydrocarbon streams removed from one or more of the gas oil crackers (e.g., hydrocracker, coker, and/or FCC) may be treated with hydrogen to remove all or a portion of one or more components such as sulfur-containing compounds (e.g., hydrogen sulfide, mercaptans, etc.), nitrogen-containing compounds, metals (e.g., vanadium, mercury, etc.), and/or chlorine-containing compounds and/or to saturate at least a portion of the olefinic and/or aromatic compounds in the stream. For example, at least a portion of the r-AGO and/or r-atmospheric resid from the ADU and/or the r-VGO and/or r-vacuum resid from the VDU (or any other heavy oil steam not shown) may be processed in at least one hydrotreating (HDT) step/unit prior to being introduced into the FCC. The hydrotreating step/unit may utilize any suitable process for removing all or a portion of one or more components such as sulfur-containing compounds (e.g., hydrogen sulfide, mercaptans, etc.), nitrogen-containing compounds, metals (e.g., vanadium, mercury, etc.) and/or to saturate at least a portion of the olefinic and/or aromatic compounds in the stream. The hydrotreating process may be performed at temperatures in the range of 250 to 500° C., or 300 to 450° C. and pressures of about 250 to over 2000 psig, or 300 to 1500 psig, depending on the feed and desired product composition. Typically, the hydrotreating process utilizes at least one catalyst. Examples of suitable catalysts include, but are not limited to, one or more metals such as cobalt, molybdenum, nickel and/or tungsten on an alumina support. Alternatively, the r-AGO and/or r-VGO (or other heavy oil stream not shown) may not be hydrotreated prior to being introduced into the FCC.

Additionally, or in the alternative, at least a portion of the r-light naphtha can be hydrotreated prior to introduction into the steam cracking facility (not shown) and/or at least a portion of the r-heavy naphtha can be hydrotreated prior to introduction into the aromatics complex. Alternatively, one or both of the r-light naphtha and r-heavy naphtha streams may not be hydrotreated prior to entering the steam cracking facility and/or the aromatics complex.

As shown in FIG. 1, at least a portion of one or more of the r-light gas and/or r-naphtha streams from the refinery and/or at least a portion of the r-pygas and/or r-pyoil from the pyrolysis facility can be introduced into a steam cracking facility to provide a recycled content pyrolysis gasoline (r-pyrolysis gasoline) stream. For example, as shown in FIG. 3, at least a portion of the r-light gas stream from the hydrocracker and/or from the FCC. Additionally, or in the alternative, at least a portion of the r-light naphtha from the hydrocracker and/or at least a portion of the r-light naphtha from the FCC may also be introduced into the steam cracking facility.

In some cases, gas-phase streams (e.g., r-pygas and/or r-light gas, optionally with another predominantly C2 to C4 gas stream with or without recycled content) can be introduced into the inlet of a steam cracker furnace in the steam cracking facility, while, in other cases, these streams may be introduced into one or more locations downstream of the furnace. When one or more liquid-phase streams (e.g., r-pyoil and/or r-light naphtha, optionally with another liquid hydrocarbon stream of similar composition with or without recycled content) are introduced into the steam cracking facility, these streams can be fed to the inlet of the steam cracking furnace.

In the steam cracking furnace, the hydrocarbon feed stream, which can include one or more of r-pygas, r-pyoil, r-light gas, and r-light naphtha as well as other recycled and/or non-recycled content hydrocarbon, can be thermally cracked in the presence of steam to form a predominantly recycled content olefin (r-olefin-containing) stream and a stream of recycled content pyrolysis gasoline (r-pyrolysis gasoline). The r-olefin-containing stream may be compressed and further processed in a separation zone of the steam cracking facility to provide one or more recycled content olefins (r-olefins), such as, r-ethylene and/or r-propylene, while a recycled content pyrolysis gasoline (r-pyrolysis gasoline), which comprises predominantly C6 to C10 aromatics, can be withdrawn from the steam cracking facility and introduced into the aromatics complex as shown in FIG. 1.

The r-pyrolysis gasoline stream comprises at least 20, at least 25, at least 30, at least 35, at least 40, at least 45, or at least 50 weight percent and/or not more than 85, not more than 80, not more than 75, not more than 70, not more than 65, or not more than 60 weight percent of recycled content benzene, recycled content toluene, and recycled content xylenes (r-BTX). In one embodiment or in combination with any embodiments mentioned herein, the r-pyrolysis gasoline can also include at least 5, at least 10, or at least 15 weight percent and/or not more than 45, not more than 35, not more than 30, or not more than 25 weight percent of recycled content C9 to C12 aromatics and/or recycled content C6 and heavier cyclic hydrocarbons (r-C6+ cyclic hydrocarbons).

The r-pyrolysis gasoline can include at least 1, at least 5, at least 10, at least 15 and/or not more than 30, not more than 25, not more than 20, not more than 15, or not more than 10 weight percent of styrene. Or, at least a portion of the styrene may be removed from the r-pyrolysis gasoline so that it includes not more than 5, not more than 2, not more than 1, or not more than 0.5 weight percent styrene. Additionally, or in the alternative, the r-pyrolysis gasoline can include at least 0.01, at least 0.05, at least 0.1, or at least 0.5 and/or not more than 5, not more than 2, not more than 1, or not more than 0.75 weight percent of one or more of cyclopentadiene and dicyclopentadiene.

In one embodiment or in combination with any embodiments mentioned herein, the r-pyrolysis gasoline can include at least 5, at least 10, at least 15, at least 20, at least 25, at least 30, at least 35, at least 40, or at least 45 weight percent and/or not more than 55, not more than 50, not more than 45, or not more than 40 weight percent of benzene, and/or at least 5, at least 10, at least 15, at least 20, at least 25, or at least 30 weight percent and/or not more than 35, not more than 30, not more than 25, not more than 20, not more than 15, or not more than 10 weight percent of toluene, based on the total amount of BTX or the total amount of the r-pyrolysis gasoline stream. Additionally, or in the alternative, the r-pyrolysis gasoline can include at least 1, at least 2, at least 5, or at least 7 weight percent and/or not more than 20, not more than 15, or not more than 10 weight percent of mixed xylenes, including ortho-xylene (oX), meta-xylene (mX), and para-xylene (pX), based on the total amount of BTX or the total amount of the r-pyrolysis gasoline stream. At least a portion of the benzene, toluene, and/or xylenes in the r-pyrolysis gasoline can comprise recycled content benzene, recycled content toluene, and/or recycled content xylenes, while, in other cases, at least a portion of the benzene, toluene, and/or xylenes may include non-recycled content.

Additionally, or in the alternative, the pyrolysis gasoline (or r-pyrolysis gasoline) can include at least 1, at least 2, at least 5, or at least 10 weight percent and/or not more than 25, not more than 20, not more than 15, or not more than 10 weight percent of other C8 aromatics, such as ethylbenzene. The pyrolysis gasoline can also include at least 1, at least 2, at least 5, or at least 10 weight percent and/or not more than 25, not more than 20, not more than 15, not more than 10, or not more than 7 weight percent of C9 and/or C10 aromatics, based on the total weight of the stream. The pyrolysis gasoline may also include little or no C5 and lighter and/or C11 and heavier components, such that these may be present in an amount of not more than 10, not more than 5, not more than 2, or not more than 1 weight percent.

Turning again to FIG. 1, at least a portion of the r-pyrolysis gasoline withdrawn from the steam cracking facility and/or at least one r-reformate stream and/or r-heavy naphtha from the refinery can be introduced into an aromatics complex. These streams may be introduced separately or combined prior and the combined stream may be introduced into the aromatics complex. In the aromatics complex, the stream or streams can be processed to provide a recycled content paraxylene (r-paraxylene) stream. The r-paraxylene stream, which comprises recycled content paraxylene (r-pX), can also include non-recycled content hydrocarbon components, including non-recycled content paraxylene (pX). The r-paraxylene stream can include at least 55, at least 60, at least 65, at least 70, at least 75, at least 80, at least 85, at least 90, at least 95, at least 97, or at least 99 percent of r-pX, based on the total amount of r-pX and pX in the stream. The total amount of paraxylene in the r-paraxylene stream (including both pX and r-pX) can be at least 85, at least 90, at least 92, at least 95, at least 97, at least 99, or at least 99.5 weight percent. In some cases, all of the paraxylene in the r-paraxylene stream can be r-pX.

Referring again to FIG. 3, at least a portion of the recycled content naphtha (r-naphtha) comprising from one or more of the FCC unit and/or hydrocracker (not shown) can be fed to a catalytic reformer, where the naphtha is reformed into a reformate stream comprising recycled content reformate (r-reformate). As used herein, the terms “reformer” or “catalytic reformer” refer to a process or facility in which a feedstock comprising predominantly C6-C10 alkanes is converted to a reformate comprising branched hydrocarbons and/or cyclic hydrocarbons in the presence of a catalyst. Exemplary catalysts include platinum and/or rhenium, although other catalysts may be used. As shown in FIG. 3, the reformer may be a refinery catalytic reforming unit.

Prior to reforming, at least a portion of the r-pyoil stream and/or r-naphtha stream may undergo hydrotreating and/or a separate nitrogen removal process (not shown). Whether or not the reformer feedstock (or the individual r-naphtha containing streams combined with the feedstock) undergoes hydrotreating and/or separate nitrogen removal, as well as where the hydrotreating process is located, will generally depend on the source and composition of any naphtha or r-naphtha streams combined with the light r-pyoil stream or otherwise included in the reformer feedstock. For example, when the feedstock comprises high olefin and/or sulfur content (e.g., greater than 10 ppm, greater than 100 ppm, greater than 500 ppm, or greater than 1,000 ppm sulfur), then hydrotreating is generally needed before introducing the feedstock to the reformer.

In one or more embodiments or in combination with any embodiment mentioned herein, at least a portion of the feedstock that undergoes reforming comprises less than 500 ppm, less than 450 ppm, less than 350 ppm, less than 250 ppm, less than 100 ppm, less than 75 ppm, less than 50 ppm, less than 25 ppm, or less than 10 ppm sulfur. In one or more embodiments, at least a portion of the feedstock that undergoes reforming comprises less than 300 ppm, less than 150 ppm, less than 100 ppm, less than 50 ppm, less than 25 ppm, less than 10 ppm, or less than 5 ppm chlorine. In one or more embodiments, at least a portion of the feedstock that undergoes reforming comprises less than 500 ppm, less than 250 ppm, less than 100 ppm, less than 75 ppm, less than 50 ppm, less than 30 ppm, or less than 20 ppm water. In one or more embodiments, at least a portion of the feedstock that undergoes reforming comprises less than 500 ppb, less than 250 ppb, less than 100 ppb, less than 50 ppb, less than 25 ppb, less than 10 ppb, less than 5 ppb, or less than 2 ppb arsenic. In one or more embodiments, at least a portion of the feedstock that undergoes reforming comprises less than 1500 ppm less than 1000 ppm, less than 500 ppm, less than 250 ppm, less than 100 ppm, less than 75 ppm, less than 50 ppm, less than 30 ppm, or less than 20 ppm nitrogen.

Regardless, the resulting feedstock can then be catalytically reformed in the reformer to produce a recycled content reformate (r-reformate). The r-reformate may then be introduced to the aromatics complex, along with any other aromatics-containing feedstock streams, and processed to produce recycled content para-xylene (r-pX), as described herein.

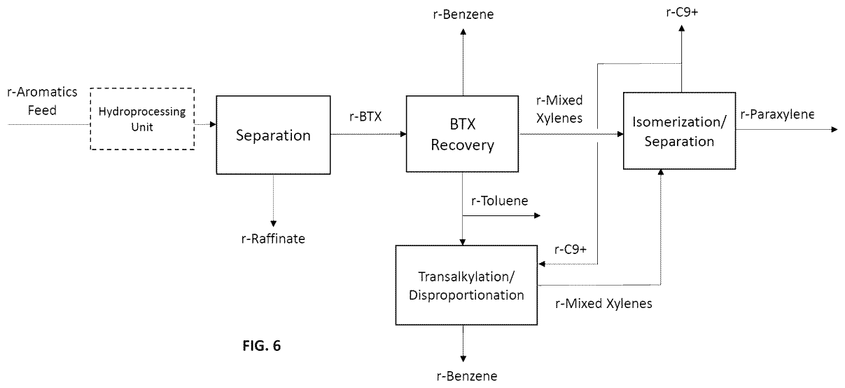

Referring now to FIG. 6, a schematic diagram of the main steps/zones of an aromatics complex as shown in FIG. 1 is provided. In one embodiment or in combination with any embodiment mentioned herein, a recycled content aromatics feed (r-aromatics feed) stream comprising predominantly C6 to C10 aromatics may be introduced into a first separation zone of the aromatics complex. The r-aromatics feed stream may comprise recycled content and it may also include non-recycled content. The stream may comprise at least 55, at least 60, at least 65, at least 70, at least 75, at least 80, or at least 85 weight percent of C6 to C10 aromatics.

The r-aromatics feed stream can comprise r-pyrolysis gasoline from one or more steam cracking facilities and/or r-reformate from one or more reformer units. At least a portion of the recycled content in these streams can be derived from waste plastic through processing one or more recycled content hydrocarbon streams such as r-pyoil, r-pygas, r-naphtha, r-light gas, or other streams in at least one steam cracking facility and/or at least one reformer unit of a refinery, according to one or more embodiments as described in further detail herein. Additionally, or in the alternative, a stream of aromatics (and/or recycled content aromatics, or r-aromatics) from one or more other processing facilities may also be included in the r-aromatics feed stream.

In one embodiment or in combination with any embodiment mentioned herein, the r-aromatics feed stream introduced into the aromatics complex (or one or more streams that make up this r-aromatics feed stream) can have one or more of the following properties (i) through (viii): (i) the stream(s) can comprise predominantly C6 to C10 (or C6 to C9) aromatics, or it can include at least 25, at least 35, at least 45, at least 55, at least 60, at least 65, at least 70, at least 75, at least 80, at least 85, or at least 90 weight percent of C6 to C10 (or C6 to C9) aromatic components; (ii), the stream(s) can comprise less than 75, less than 65, less than 55, less than 45, less than 35, less than 25, less than 15, or less than 10 weight percent of non-aromatic components; (iii) the streams can comprise at least 1, at least 2, at least 3, at least 5, or at least 10 and/or not more than 30, not more than 25, not more than 20, not more than 15, not more than 10, or not more than 7 weight percent of benzene, which may include recycled content benzene (r-benzene) and/or non-recycled content benzene; (iv) the stream(s) can comprise at least 5, at least 10, at least 15, or at least 20 and/or not more than 40, not more than 35, not more than 30, not more than 25, or not more than 20 weight percent of toluene, which can include both recycled content toluene (r-toluene) and/or non-recycled content toluene; (v) the stream(s) can comprise at least 2, at least 5, at least 10, at least 15, at least 20, or at least 25 weight percent and/or not more than 75, not more than 70, not more than 65, not more than 60, not more than 55, not more than 50, not more than 45, not more than 40, not more than 35, not more than 30, or not more than 25 weight percent of one or more of C8 aromatics (or recycled content C8 aromatics, r-C8 aromatics), C9 aromatics (or recycled content C9 aromatics, r-C9 aromatics), and C10 aromatics (or recycled content C10 aromatics, r-C10 aromatics, individually or in combination; (vi) the stream(s) can comprise at least 5, at least 10, or at least 15 and/or not more than 50, not more than 45, or not more than 40 weight percent of mixed xylenes, including recycled and non-recycled content xylenes; (vii) the stream(s) may comprise not more than 15, not more than 10, not more than 5, not more than 2, or not more than 1 weight percent of C5 and lighter components and/or C11 and heavier components; and (viii) the stream(s) can comprise a total amount of C6 to C10 (or C9 to C10) hydrocarbon components of at least 55, at least 60, at least 65, at least 70, at least 75, at least 80, at least 85, or at least 90 weight percent, based on the total weight of the stream

Examples of C8 aromatics include, but are not limited to, mixed xylenes such as ortho-xylene, para-xylene, and meta-xylene, as well as ethylbenzene, and styrene, while C9 aromatics can include, for example, isopropyl benzene, propyl benzene, isomers of methyl ethyl benzene, isomers of methyl styrenes, and isomers of trimethyl benzene. Examples of C10 aromatics can include, but are not limited to, isomers of butyl benzene, isomers of diethyl benzene, and isomers of dimethyl ethyl benzene. One or more of these components, when present in the aromatics stream, may include recycled content and/or may include non-recycled content.

In one embodiment or in combination with any embodiment mentioned herein, the r-aromatics stream may comprise 20 to 80, or 25 to 75, or 30 to 60 weight percent benzene and/or 0.5 to 40, or 1 to 35, or 2 to 30 weight percent toluene, and/or 0.05 to 30, or 0.10 to 25, or 0.20 to 20 weight percent of C8 aromatics, based on the total weight of aromatics in the r-aromatics stream.

As shown in FIGS. 1 and 6, at least a portion of the r-aromatics stream (which may include, for example, an r-pyrolysis gasoline stream from a steam cracking facility and/or an r-reformate stream from a reformer unit of a refinery and/or an r-naphtha stream from another refinery process described herein) can be introduced into an initial separation zone in the aromatics complex. In one embodiment or in combination with any embodiments mentioned herein, two or more of the feed streams (e.g., r-naphtha, r-reformate, r-pyrolysis gasoline, r-aromatics, and yet-to-be-discussed r-raffinate) may also be introduced into the initial separation zone separately or two or more of these streams may be combined and the combined stream introduced into the separation zone.

As shown in FIG. 6, at least a portion of the r-aromatics feed stream may optionally be hydrotreated prior to entering the initial separation zone of the aromatics complex. When present, this hydrotreating zone may hydrogenate the streams to reduce at least a portion of the unsaturated carbon-carbon bonds to form saturated carbon-carbon bonds. The hydrotreating unit may include one or more hydrotreating (e.g., hydrogenation) reactors containing a catalyst, such as nickel, palladium, rhodium, ruthenium, or platinum-containing catalysts. The resulting hydrotreated (e.g., hydrogenated) stream may then be introduced into the initial separation zone of the aromatics complex, as shown in FIG. 6.

The initial separation zone of the aromatics complex shown in FIG. 6 can utilize any suitable method for separating at least a portion of the aromatics out of the feed streams introduced into the separation zone. In one embodiment or in combination with any embodiments mentioned herein, the initial separation zone may remove at least 50, at least 60, at least 75, at least 80, or at least 90 weight percent of the total amount of aromatics introduced into the separation zone, resulting in an aromatics-enriched predominantly benzene, toluene, and xylene (BTX) stream and an aromatics-depleted raffinate stream. The BTX stream may comprise at least at least 55, at least 65, at least 75, at least 85, or at least 90 weight percent C6 to C9 aromatics, while the raffinate stream can comprise less than 50, less than 40, less than 30, less than 20, or less than 10 weight percent C6 to C9 aromatics. When one or more of the feed streams to the initial separation zone comprise recycled content, the BTX stream can be a recycled content BTX (r-BTX) stream, and the raffinate stream may be a recycled content raffinate (r-raffinate) stream.

In addition to BTX, the r-BTX stream may include other aromatic and non-aromatic components. For example, the r-BTX (or BTX) stream may include at least 1, at least 2, at least 5, or at least 10 weight percent and/or not more than 25, not more than 20, not more than 15, or not more than 10 weight percent of C9 and heavier (or C10 and heavier) components. Such components can include C9 and heavier (or C10 and heavier) aromatic components as well as non-aromatic C9 and heavier (or C10 and heavier) components.

The separation step carried out in the initial separation zone of the aromatics complex can may be performed using any suitable type of separation, including extraction, distillation, and extractive distillation. When the separation step includes extraction or extractive distillation, it may utilize at least one solvent selected from the group consisting of sulfolane, furfural, tetraethylene glycol, dimethylsulfoxide, N,N-dimethylformamide, and N-methyl-2-pyrrolidone. When the initial separation step includes distillation, it may be performed in one or more distillation columns. Upon separation, the r-raffinate stream depleted in aromatics can be withdrawn from the separation step/zone. The r-raffinate stream comprises predominantly C5 and heavier, or C5 to C12 components, and may include not more than 20, not more than 15, not more than 10, not more than 5 weight, not more than 2, or not more than 1 percent of C6 to C10, or C6 to C9, or C6 to C8 aromatics (e.g., benzene, toluene, and xylenes). The r-raffinate stream withdrawn from the aromatics complex can comprise predominantly C4 to C8, C5 to C7, or C5 and C6 hydrocarbon components, or it can include at least 55, at least 60, at least 65, at least 70, or at least 75 weight percent of these compounds.

As shown in FIG. 1, the r-raffinate stream from the aromatics complex may optionally be introduced into a steam cracking facility and/or a reformer. Within the reformer and/or steam cracker, the r-raffinate stream may be further processed to form another r-pyrolysis gasoline and/or another r-reformate stream to provide another C6 to C10 aromatics (or r-C6 to C10 aromatics) stream that can be reintroduced into the aromatics complex.

Referring again to FIG. 6, a stream concentrated in recycled content benzene, toluene, and xylenes (r-BTX) can also be withdrawn from the initial separation step. This r-BTX stream comprises predominantly BTX and may include at least 60, at least 70, at least 80, at least 85, at least 90, or at least 95 BTX, including both recycled content BTX (r-BTX) and non-recycled content BTX, as applicable. The r-BTX stream can be introduced into a downstream BTX recovery zone, which utilizes one or more separation steps to provide streams concentrated in recycled content benzene (r-benzene), recycled content mixed xylenes (r-mixed xylenes), and recycled content toluene (r-toluene). Such separations can be performed according to any suitable method, including, for example, with one or more distillation columns or other separation equipment or steps such extraction, crystallization, and/or adsorption. As discussed previously, this r-BTX stream may include other C8 aromatics (such as ethylbenzene), as well as C9 and heavier (or C10 and heavier) components in addition to the benzene, toluene, and mixed xylenes. Components other than BTX in the r-BTX stream may be present in an amount of at least 1, at least 2, at least 5, or at least 10 weight percent and/or not more than 25, not more than 20, not more than 15, or not more than 10 weight percent.

As shown in FIG. 6, the r-benzene formed in BTX recovery step can be removed as a product stream from aromatics complex, while the r-mixed xylenes can be introduced into a second separation step for separating out recycled content ortho-xylene (r-oX), recycled content meta-xylene (r-mX), and/or recycled content paraxylene (r-pX) from the other components in the stream. In addition to comprising at least 25, at least 30, at least 35, at least 40, or at least 45 weight percent and/or not more than 70, not more than 65, not more than 60, or not more than 55 weight percent mixed xylenes, this stream of r-mixed xylenes may also include other C8 aromatics (such as ethylbenzene), as well as C9 and heavier (or C10 and heavier) aromatic and non-aromatic components. Such components (which may include recycled content or non-recycled content components) can be present in the r-BTX stream in an amount of at least 1, at least 2, at least 5, or at least 10 weight percent and/or not more than 35, not more than 30, not more than 25, not more than 20, not more than 15, not more than 10, or not more than 5 weight percent.

This second separation step can utilize one or more of distillation, extraction, crystallization, and adsorption to provide recycle content aromatics streams. For example, as shown in FIG. 6, the separation step can provide at least one of a recycled content paraxylene (r-paraxylene) stream, a recycled content metaxylene (r-metaxylene) stream, and a recycled content orthoxylene (r-orthoxylene) stream. Each of these streams may include both recycled and non-recycled content and can individually include at least 75, at least 80, at least 85, at least 90, at least 95, or at least 97 weight percent of paraxylene (r-pX and pX), metaxylene (r-mX and mX), or orthoxylene (r-oX and oX), respectively.

Additionally, at least a portion of the oX (or r-oX) and/or mX (or r-mX) can be subjected to isomerization to provide additional pX (or r-pX). After the isomerization, additional separation steps may be performed to provide individual streams of oX (or r-oX), mX (or r-mX), and pX (or r-pX).

As shown in FIG. 6, a stream of recycled content C9 and heavier components (r-C9+ components) may also be withdrawn from the second separation step and all or a portion may be introduced into a transalkylation/disproportionation step along with a stream of r-toluene withdrawn from the BTX recovery step/zone. In the transalkylation/disproportionation step/zone, at least a portion of the toluene (or r-toluene) can be reacted in the presence of a regenerable fixed bed silica-alumina catalyst to provide mixed xylenes (or r-mixed xylenes) and benzene (or r-benzene). Alternatively, or in addition, at least a portion of the r-toluene can be reacted with methanol (and, optionally, r-methanol) to provide recycled content paraxylene (r-paraxylene), which may be further processed as described herein. In some cases, this reaction may be performed within the aromatics complex over an acidic catalyst, preferably on a shape-selective molecular sieve catalyst such as ZSM-5, and the resulting r-paraxylene may be combined with other paraxylene (or r-paraxylene) recovered in the aromatics complex, as shown in FIG. 6. As shown in FIG. 6, the benzene (or r-benzene) can be recovered as a product, while the r-mixed xylenes can be introduced into the second separation step/zone for further separation into a r-paraxylene stream, an r-orthoxylene stream, and a r-metaxylene stream.

Turning back to FIG. 1, at least a portion of the r-paraxylene stream withdrawn from the aromatics complex can be sent to a TPA production facility. In the TPA production facility, at least a portion of the pX (and/or r-pX) in the r-paraxylene stream can be oxidized in the presence of a solvent (e.g., acetic acid) and a catalyst to form recycled content crude terephthalic acid (r-CTA).

Thereafter, depending on the specific TPA production process utilized within the production facility, the r-CTA can either be oxidized again in a secondary or post-oxidation step or it can be hydrogenated in a treatment step to form recycled content purified terephthalic acid (r-PTA). All or a portion of the solvent may be removed from the r-CTA and swapped out for new solvent, which may be the same as or different than the original solvent. The resulting r-PTA slurry can be processed by, for example, drying, crystallization, and filtration to provide the final r-TPA product.

In one embodiment or in combination with any embodiments mentioned herein, as shown in FIG. 1, at least a portion of the r-TPA product can be introduced into a PET production facility and reacted with at least one diol (such as, for example, ethylene glycol) to form recycled content polyethylene terephthalate (r-PET). In one embodiment or in combination with any embodiments mentioned herein, the r-TPA and ethylene glycol (or, recycled content ethylene glycol, r-EG) can be polymerized in the presence of one or more comonomers, such as isophthalic acid or neopentyl glycol or cyclohexanedimethanol, to form a recycled content PET copolymer (r-co-PET).

### DEFINITIONS

It should be understood that the following is not intended to be an exclusive list of defined terms. Other definitions may be provided in the foregoing description, such as, for example, when accompanying the use of a defined term in context.

As used here, the term “light gas” refers to a hydrocarbon-containing stream comprising at least 50 weight percent of C4 and lighter hydrocarbon components. Light hydrocarbon gas may include other components such as nitrogen, carbon dioxide, carbon monoxide, and hydrogen, but these are typically present in amount of less than 20, less than 15, less than 10, or less than 5 weight percent, based on the total weight of the stream.

As used herein, the terms “median boiling point” or “T50” refers to the median boiling point of a process stream (i.e., the temperature value where 50 weight percent of the stream composition boils above the temperature value and 50 weight percent of the stream composition boils below the temperature value).

As used herein, the term “boiling point range” or “cut point” refers to the range of temperatures over which a specified petroleum fraction boils. The lower value in a boiling point range is the initial boiling point (IBP) temperature for that specified fraction and the higher value is the end point (EP) temperature for that specified fraction.

As used herein, the term “naphtha” refers to a physical mixture of hydrocarbon components separated in at least one distillation column of a refining facility that has a boiling point range between 90 to 380° F.

As used herein, the term “light naphtha” refers to a specific portion of a naphtha cut in a refinery having a boiling point range between 90 and less than 230° F.

As used herein, the term “heavy naphtha” refers to a specific portion of a naphtha cut in a refinery having a boiling point range between 230 and 380° F.

As used herein, the terms “distillate” and “kerosine” refer to a physical mixture of hydrocarbon components separated in at least one distillation column of a refining facility that has a boiling point range greater than 380 to 520° F.

As used herein, the term “hydrocracker distillate” refers to a distillate cut removed from a hydrocracker unit.

As used herein, the term “gas oil” refers to a physical mixture of hydrocarbon components separated in at least one distillation column of a refining facility that has a boiling point range greater than 520 to 1050° F.

As used herein, the term “hydrocracker gas oil” refers to a gas oil cut removed from a hydrocracker unit.

As used herein, the term “atmospheric gas oil” refers to a gas oil produced by the atmospheric distillation unit.

As used herein, the term “light gas oil” or “LGO” refers to a specific portion of gas oil cut in a refinery having a boiling point range between greater than 520 and 610° F.

As used herein, “light vacuum gas oil” or “LVGO” refers to a light gas oil produced by the vacuum distillation unit.

As used herein, “light vacuum gas oil” or “LCGO” refers to a light gas oil produced by the coker unit.

As used herein, the term “heavy gas oil” or “HGO” refers to a specific portion of a gas oil cut in a refinery having a boiling point range between greater than 610 and 800° F.

As used herein, “heavy vacuum gas oil” or “HVGO” refers to a heavy gas oil produced by the vacuum distillation unit.

As used herein, “heavy coker gas oil” or “HCGO” refers to a heavy gas oil produced by the coker unit.

As used herein, the term “vacuum gas oil” or “VGO” refers to a specific portion of a gas oil cut in a refinery having a boiling point range between greater than 800 and 1050° F. Vacuum gas oil is separated from the initial crude oil using a vacuum distillation column operated at a pressure below atmospheric pressure.

As used herein, the term “residue” or “resid” refers to the heaviest cut from a distillation column in a refinery and having a boiling point range between greater than 1050° F.

As used herein, the term “vacuum resid” refers to a resid product from the vacuum distillation column.

As used herein, the term “atmospheric resid” refers to a resid product from the atmospheric distillation column.

As used herein, the term “gas plant” refers to equipment, including one or more distillation columns as well as ancillary equipment as well as pumps, compressors, valves, etc. in a refinery for processing a hydrocarbon feed stream comprising predominantly C6 and lighter components to provide one or more purified streams of C1 to C6 alkanes and/or olefins.

As used herein, the term “saturated gas plant” refers to a gas plant in a refinery for processing a hydrocarbon feed stream comprising predominantly saturated hydrocarbons (alkanes). The feed stream to a saturated gas plant includes less than 5 weight percent of olefins, based on the total feed to the plant. The feed to a saturated gas plant in a refinery may come, directly or indirectly, from the crude distillation unit or vacuum distillation unit and may undergo little or no cracking.

As used herein, the term “unsaturated gas plant” refers to a gas plant in a refinery for processing a hydrocarbon feed stream comprising saturated hydrocarbons (alkanes) and unsaturated hydrocarbons (olefins). The feed stream to an unsaturated gas plant includes at least 5 weight percent of olefins, based on the total feed to the plant. The feed to a saturated gas plant in a refinery may come indirectly from the crude unit or vacuum distillation unit and may undergo one or more cracking steps prior to entering the gas plant.

As used herein, the term “gas oil cracker” refers to a cracking unit for processing a feed stream comprising predominantly gas oil and heavier components. Although a gas oil cracker can process lighter components, such as distillate and naphtha, at least 50 weight percent of the total feed to a gas oil cracker includes gas oil and heavier components. Gas oil crackers may be operated at temperatures of at least 350° F., at least 400° F., at least 450° F., at least 500° F., at least 550° F., or at least 600° F. and/or not more than 1200° F., not more than 1150° C., not more than 1100° F., not more than 1050° F., not more than 1000° F., not more than 900° F., or not more than 800° F. Gas oil crackers may be operated at or near atmospheric pressure (e.g., at a pressure of less than 5 psig, less than 2 psig, or 1 psig) or may be operated at elevated pressure (e.g., at a pressure of at least 5 psig, at least 10 psig, at least 25 psig, at least 50 psig, at least 100 psig, at least 250 psig, at least 500 psig, or at least 750 psig.) Additionally, the cracking in gas oil crackers may be carried with or without a catalyst, and it may or may not be conducted in the presence of hydrogen and/or steam.

As used herein, the term “fluidized catalytic cracker” or “FCC” refers to a set of equipment, including a reactor, a regenerator, a main fractionator, as well as ancillary equipment such as pipes, valves, compressors, and pumps, for reducing the molecular weight of a heavy hydrocarbon stream via catalytic cracking in a fluidized catalyst bed.

As used herein, the terms “reformer” or “catalytic reformer” refer to a process or facility in which a feedstock comprising predominantly C6-C10 alkanes is converted to a reformate comprising branched hydrocarbons and/or cyclic hydrocarbons in the presence of a catalyst.

As used herein, the term “reformate” refers to a liquid product stream produced by a catalytic reformer process.

As used herein, the term “hydroprocessing” refers to chemical processing of a hydrocarbon stream with or in the presence of hydrogen. Hydroprocessing is typically a catalytic process and includes hydrocracking and hydrotreating.

As used herein, the term “hydrocracking” refers a type of hydroprocessing where the hydrocarbon molecules are cracked (i.e., undergo a reduction in molecular weight).

As used herein, the term “hydrotreating” refers to a type of hydroprocessing that does not crack the hydrocarbon molecules, but instead removes oxygen, sulfur, and other heteroatoms by hydrogenolysis or to saturate unsaturated bonds by hydrogenation. It may or may not be carried out in the presence of a catalyst.

As used herein, the term “distillation” refers to separation of a mixture of components by boiling point difference.

As used herein, the term “atmospheric distillation” refers to distillation performed at a pressure at or near atmospheric, usually to separate crude oil and/or other streams into specified fractions for further processing.

As used herein, the term “vacuum distillation” refers to distillation performed at a pressure below atmospheric and, usually, at a pressure of less than 100 mm Hg at the top of the column.

As used herein, the term “coking” refers to thermal cracking of heavy hydrocarbons (usually atmospheric or vacuum column bottoms) performed to recover light, more valuable products such as naphtha, distillate, gas oil, and light gas.

As used herein, the term “aromatics complex” refers to a process or facility in which a mixed hydrocarbon feedstock, such as a reformate, is converted into one or more benzene, toluene, and/or xylene (BTX) product streams, such as a para-xylene product stream. The aromatics complex may comprise one or more processing steps, in which one or more components of the reformate are subjected to at least one of a separation step, an alkylation step, a transalkylation step, a toluene disproportionation step, and/or an isomerization step. The separation step can comprise one or more of an extraction step, a distillation step, a crystallization step, and/or an adsorption step.

As used herein, the term “raffinate” refers to the aromatics-depleted stream removed from the initial separation step in the aromatics complex. Although most commonly used to refer to a stream withdrawn from an extraction step, the term “raffinate” as used with respect to the aromatics complex can also refer to a stream withdrawn from another type of separation, including, but not limited to, distillation or extractive distillation.

As used herein, the terms “pyrolysis oil” or “pyoil” refers to a composition obtained from pyrolysis that is liquid at 25° C. and 1 atm, absolute.

As used herein, the terms “pyrolysis gas” and “pygas” refer to a composition obtained from pyrolysis that is gaseous at 25° C. and 1 atm, absolute.

As used herein, the term “pyrolysis” refers to thermal decomposition of one or more organic materials at elevated temperatures in an inert (i.e., substantially oxygen free) atmosphere.

As used herein, the term “pyrolysis vapor” refers to the overhead or vapor-phase stream withdrawn from the separator in a pyrolysis facility used to remove r-pyrolysis residue from the r-pyrolysis effluent.

As used herein, the term “pyrolysis effluent” refers to the outlet stream withdrawn from the pyrolysis reactor in a pyrolysis facility.

As used herein, the term “r-pyrolysis residue” refers to a composition obtained from waste plastic pyrolysis that comprises predominantly pyrolysis char and pyrolysis heavy waxes.

As used herein, the term “pyrolysis char” refers to a carbon-containing composition obtained from pyrolysis that is solid at 200° C. and 1 atm, absolute.

As used herein, the term “pyrolysis heavy waxes” refers to C20+ hydrocarbons obtained from pyrolysis that are not pyrolysis char, pyrolysis gas, or pyrolysis oil.

As used herein, the term “pyrolysis gasoline” refers to a hydrocarbon stream of predominantly C5 and heavier components removed from a quench section of a steam cracking facility. Typically, pyrolysis gasoline includes at least 10 weight percent of C6 to C9 aromatics.

As used herein, the term “lighter” refers to a hydrocarbon component or fraction having a lower boiling point than another hydrocarbon component or fraction.

As used herein, the term “heavier” refers to a hydrocarbon component or fraction having a higher boiling point than another hydrocarbon component or fraction.

As used herein, the term “upstream” refers to an item of facility that is positioned prior to another item or facility in a given process flow and may include intervening items and/or facilities.

As used herein, the term “downstream” refers to an item or facility that is positioned after another item or facility in a given process flow and may include intervening items and/or facilities.

As used herein, the term “alkane” refers to a saturated hydrocarbon including no carbon-carbon double bonds.

As used herein, the term “olefin” refers to an at least partially unsaturated hydrocarbon including at least one carbon-carbon double bond.

As used herein, the terms “Cx” or “Cx hydrocarbon” or “Cx component” refers to a hydrocarbon compound including “x” total carbons per molecule, and encompasses all olefins, paraffins, aromatics, heterocyclic, and isomers having that number of carbon atoms. For example, each of normal, iso, and tert-butane and butene and butadiene molecules would fall under the general description “C4” or “C4 components.”

As used herein, the terms “r-para-xylene” or “r-pX” refer to being or comprising a para-xylene product that is directly and/or indirectly derived from waste plastic.

As used herein, the term “cracking” refers to breaking down complex organic molecules into simpler molecules by the breaking of carbon-carbon bonds.

As used herein, the term “steam cracking” refers to thermal cracking of hydrocarbons in the presence of steam, usually performed in a furnace of the steam cracking facility.

As used herein, the term “co-located” refers to the characteristic of at least two objects being situated on a common physical site, and/or within five miles of each other, measured as a straight-line distance between two designated points.

As used herein, the term “commercial scale facility” refers to a facility having an average annual feed rate of at least 500 pounds per hour, averaged over one year.

As used herein, the terms “crude” and “crude oil” refer to a mixture of hydrocarbons that exists in liquid phase and is derived from natural underground reservoirs.

As used herein, the terms “recycle content” and “r-content” refer to being or comprising a composition that is directly and/or indirectly derived from waste plastic.

As used herein, the term “predominantly” means more than 50 percent by weight. For example, a predominantly propane stream, composition, feedstock, or product is a stream, composition, feedstock, or product that contains more than 50 weight percent propane.

As used herein, the term “waste material” refers to used, scrap, and/or discarded material.

As used herein, the terms “waste plastic” and “plastic waste” refer to used, scrap, and/or discarded plastic materials.

As used herein, the terms “mixed plastic waste” and “MPW” refer to a mixture of at least two types of waste plastics including, but not limited to the following plastic types: polyethylene terephthalate (PET), one or more polyolefins (PO), and polyvinylchloride (PVC).

As used herein, the term “fluid communication” refers to the direct or indirect fluid connection between two or more processing, storage, or transportation facilities or zones.

As used herein, the terms “a,”“an,”and “the”mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the phrase “at least a portion” includes at least a portion and up to and including the entire amount or time period.

As used herein, the term “chemical recycling” refers to a waste plastic recycling process that includes a step of chemically converting waste plastic polymers into lower molecular weight polymers, oligomers, monomers, and/or non-polymeric molecules (e.g., hydrogen, carbon monoxide, methane, ethane, propane, ethylene, and propylene) that are useful by themselves and/or are useful as feedstocks to another chemical production process(es).

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the term “cracking” refers to breaking down complex organic molecules into simpler molecules by the breaking of carbon-carbon bonds.

As used herein, the terms “including,” “include,” and “included” have the same open-ended meaning as “comprising,” “comprises,” and “comprise” provided above.

As used herein, the term “predominantly” means more than 50 percent by weight. For example, a predominantly propane stream, composition, feedstock, or product is a stream, composition, feedstock, or product that contains more than 50 weight percent propane.

As used herein, the term “chemical pathway” refers to the chemical processing step or steps (e.g., chemical reactions, physical separations, etc.) between an input material and a product, where the input material is used to make the product.

As used herein, the terms “credit-based recycled content,” “non-physical recycled content,” and “indirect recycled content” all refer to matter that is not physically traceable back to a waste material, but to which a recycled content credit has been attributed.

As used herein, the term “directly derived” refers to having at least one physical component originating from waste material.

As used herein, the term “indirectly derived” refers to having an applied recycled content (i) that is attributable to waste material, but (ii) that is not based on having a physical component originating from waste material.

As used herein, the term “located remotely” refers to a distance of at least 0.1, 0.5, 1, 5, 10, 50, 100, 500, or 1000 miles between two facilities, sites, or reactors.

As used herein, the term “mass balance” refers to a method of tracing recycled content based on the mass of the recycled content in a product.

As used herein, the terms “physical recycled content” and “direct recycled content” both refer to matter physically present in a product and that is physically traceable back to a waste material.

As used herein, the term “recycled content” refers to being or comprising a composition that is directly and/or indirectly derived from recycled waste material. Recycled content is used generically to refer to both physical recycled content and credit-based recycled content. Recycled content is also used as an adjective to describe a product having physical recycled content and/or credit-based recycled content.

As used herein, the term “recycled content credit” refers to a non-physical measure of physical recycled content obtained from a mass of waste plastic that can be directly or indirectly (i.e., via a digital inventory) attributed to a product.

As used herein, the term “total recycled content” refers to the cumulative amount of physical recycled content and credit-based recycled content from all sources.

As used herein, the term “waste material” refers to used, scrap, and/or discarded material.

As used herein, the terms “waste plastic” and “plastic waste” refer to used, scrap, and/or discarded plastic materials, including post-industrial or pre-consumer waste plastic and post-consumer waste plastic.

As used herein, the term “hydrocarbon” refers to an organic chemical compound that includes only carbon and hydrogen atoms.

As used herein, the term “organic chemical compound,” refers to a chemical compound that includes carbon and hydrogen atoms, but also includes oxygen and/or nitrogen atoms.

As used herein, the term “hydroprocessing unit” refers to a set of equipment, including reaction vessels, a drier, and a main fractionator, as well as ancillary equipment such as pipes, valves, compressors, and pumps, for chemically processing a hydrocarbon stream in the presence of hydrogen. Specific examples of hydroprocessing units include a hydrocracker (or hydrocracking unit) configured to carry out a hydrocracking process and a hydrotreater (or hydrotreating unit) configured to carry out a hydrotreating process.

As used herein, the term “coker” or “coking unit” refers to a set of equipment, including reaction vessels, a drier, and a main fractionator, as well as ancillary equipment such as pipes, valves, compressors, and pumps, for reducing the molecular weight of a heavy hydrocarbon stream via thermal cracking or coking.

As used herein, the terms “steam cracking facility” or “steam cracker” refer to all of the equipment needed to carry out the processing steps for thermally cracking a hydrocarbon feed stream in the presence of steam to form one or more cracked hydrocarbon products. Examples include, but are not limited to, olefins such as ethylene and propylene. The facility may include, for example, a steam cracking furnace, cooling equipment, compression equipment, separation equipment, as well as the pipes, valves, tanks, pumps, etc. needed to carry out the processing steps.

As used herein, the terms “refinery,” “refining facility,” and “petroleum refinery,” refer to all of the equipment needed to carry out the processing steps for separating and converting petroleum crude oil into multiple hydrocarbon fractions, one or more of which can be used as a fuel source, lube oil, bitumen, coke, and as an intermediate for other chemical products.” The facility may include, for example, separation equipment, thermal or catalytic cracking equipment, chemical reactors, and product blending equipment, as well as the pipes, valves, tanks, pumps, etc. needed to carry out the processing steps.

As used herein, the term “pyrolysis facility,” refers to all of the equipment needed to carry out the processing steps for pyrolyzing a hydrocarbon-containing feed stream, which can include or be waste plastic. The facility may include, for example, reactors, cooling equipment, and separation equipment, as well as the pipes, valves, tanks, pumps, etc. needed to carry out the processing steps.

As used herein, the term “terephthalic acid production facility,” or “TPA production facility,” refers to all of the equipment needed to carry out the processing steps for forming terephthalic acid from paraxylene. The facility may include, for example, reactors, separators, cooling equipment, separation equipment such as filters or crystallizers, as well as the pipes, valves, tanks, pumps, etc. needed to carry out the processing steps.

As used herein, the term “polyethylene terephthalate production facility,” or “PET production facility,” refers to all of the equipment needed to carry out the processing steps for forming polyethylene terephthalate (PET) from a terephthalate, ethylene glycol, and, optionally, one or more additional monomers. The facility may include, for example, polymerization reactors, cooling equipment, and equipment to recover solidified and/or pelletized PET, as well as the pipes, valves, tanks, pumps, etc. needed to carry out the processing steps.

### DISCLOSURE OF CERTAIN EMBODIMENTS

In one aspect, a method for producing a recycled content organic chemical compound (r-organic chemical compound or r-occ) is provided. Embodiments of this r-occ method can include the following:
Embodiment r-occ 1 (E r-occ 1). A method for producing a recycled content organic chemical compound (r-organic chemical compound), the method comprising:
   (a) introducing a recycled content aromatics-containing stream into an aromatics complex, wherein the aromatics-containing stream comprising a recycled content FCC naphtha (r-FCC naphtha) stream, a recycled content reformate (r-reformate) stream, and/or a recycled content pyrolysis gasoline (r-pyrolysis gasoline) stream, wherein:
      (i) the r-FCC naphtha stream is obtained by catalytically cracking a liquified waste plastic material;
      (ii) the r-reformate stream is obtained by reforming at least a first portion of the r-FCC naphtha stream; and/or
      (iii) the r-pyrolysis gasoline stream is obtained by steam cracking at least a second portion of the r-FCC naphtha stream, optionally with a recycled content light gas; and
   (b) processing the aromatics-containing stream in the aromatics complex to provide an r-pX stream comprising at least 85 weight percent para-xylene.
E r-occ 2. The method of E r-occ 1, wherein at least a portion of the r-pX stream is oxidized in a terephthalic acid (TPA) facility to provide a stream comprising recycled content TPA (r-TPA).
E r-occ 3. The method of E r-occ 2, wherein at least a portion of the r-TPA is reacted with ethylene glycol (r-EG) in a polyethylene terephthalate (PET) production facility to provide recycled content PET (r-PET).
E r-occ 4. The method of any one of Embodiments r-occ 1-3, wherein the processing (b) comprises subjecting one or more components of the aromatics-containing stream to at least one of a separation step, an alkylation step, a transalkylation step, a toluene disproportionation step, and an isomerization step.
E r-occ 5. The method of E r-occ 4, wherein the separation step comprises one or more of an extraction step, a distillation step, a crystallization step, and/or an adsorption step.
E r-occ 6. The method of any one of Embodiments r-occ 1-5, wherein the aromatics-containing stream comprises recycled content benzene, toluene, and xylenes (r-BTX) and wherein said processing of step (b) includes extraction of at least a portion of the r-BTX from the aromatics-containing stream to form an r-BTX stream and a recycled content raffinate (r-raffinate) stream.
E r-occ 7. The method of E r-occ 6, wherein the extraction is performed using a solvent.
E r-occ 8. The method of Er-occ 7, wherein the solvent is selected from the group consisting of sulfolane, furfural, tetraethylene glycol, dimethylsulfoxide, and N-methyl-2-pyrrolidone.
E r-occ 9. the Method of E r-occ 6, Wherein the Extraction Is Performed With extractive distillation.
E r-occ 10. The method of any one of Embodiments r-occ 6-9, further comprising separating at least a portion of the r-BTX stream in one or more distillation columns to provide streams of recycled content benzene (r-benzene), recycled content toluene (r-toluene), and recycled content mixed xylenes (r-mixed xylenes).
E r-occ 11. A method for producing a recycled content organic chemical compound (r-organic chemical compound), the method comprising:
   (a) introducing a stream of recycled content paraxylene (r-pX) into a terephthalic acid (TPA) production facility, wherein at least a portion of the r-pX is obtained by liquifying waste plastic to form a liquified waste plastic stream, introducing at least a portion of the liquified waste plastic stream into a fluidized catalytic cracker unit and/or a hydrocracker unit, recovering a recycled content FCC naphtha (r-FCC naphtha) stream from the FCC unit and/or a recycled content HDC naphtha (r-HDC naphtha) stream from the hydrocracker unit, wherein the r-FCC naphtha stream and/or the r-HDC naphtha stream comprises at least one aromatics-containing stream and/or wherein the r-FCC naphtha stream and/or the r-HDC naphtha stream are further processed to produce at least one aromatics-containing stream, and processing at least a portion of the at least one aromatics-containing stream in an aromatics complex to produce the stream of r-pX; and
   (b) processing at least a portion of the r-pX in the TPA production facility to provide recycled content purified terephthalic acid (r-TPA)
E r-occ 12. The method of E r-occ 11, wherein the processing of step (b) includes oxidizing at least a portion of the r-pX to form recycled content crude terephthalic acid (r-CTA).
E r-occ 13. The method of E r-occ 12, wherein the processing of step (b) includes purifying at least a portion of the r-CTA to provide recycled content purified terephthalic acid (r-TPA).
E r-occ 14. The method of E r-occ 12, wherein the oxidizing is carried out in a first solvent and the purifying includes a second-stage oxidation step performed in a second solvent different than the first solvent.
E r-occ 15. The method of E r-occ 13, wherein the purifying includes hydrogenation.
E r-occ 16. The method of E r-occ 14, wherein the purifying includes crystallization.
E r-occ 17. The method of any one of Embodiments r-occ 11-16, wherein the r-pX stream comprises at least 85, at least 90, at least 95, at least 97, or at least 99 weight percent of para-xylene.
E r-occ 18. The method of any one of Embodiments r-occ 11-17, wherein at least a portion of the r-TPA is further reacted with ethylene glycol in a polyethylene terephthalate (PET) production facility to provide recycled content PET (r-PET).

### CLAIMS NOT LIMITED TO DISCLOSED EMBODIMENTS

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A chemical recycling process comprising:
(a) liquifying waste plastic to form a liquified waste plastic stream; and
(b) introducing at least a portion of the liquified waste plastic stream into a fluidized catalytic cracker (FCC) unit and/or a hydrocracking unit,
wherein the waste plastic comprises predominantly polyolefins.

2. The process of claim 1, wherein the waste plastic comprises at least 90 weight percent of one or more polyolefins and/or not more than 5 weight percent of polyethylene terephthalate (PET).

3. The process of claim 1, further comprising introducing a mixed plastic waste (MPW) to one or more preprocessing steps to produce the waste plastic that is liquified (a), wherein the one or more preprocessing steps comprises size reducing, density separating, washing/rinsing, filtering, and/or drying the mixed plastic waste; or wherein the one or more preprocessing steps produces at least a polyolefins (PO)-enriched (PET-depleted) stream and a PET-enriched (PO-depleted) stream and at least a portion of the PO-enriched stream comprises at least a portion of the waste plastic that is liquified (a).

4. The process of claim 1, wherein the liquefying comprises melting, plasticizing, dissolving, and/or depolymerizing the waste plastic; or
wherein the liquefying comprises melting the waste plastic in a melt tank maintained at a temperature in the range of 200 to 500° C.; or
wherein the liquefying comprises dissolving or solvating the waste plastic with at least one solvent, optionally, wherein the solvent is selected from the group consisting of alcohols, glycols, cyclohexanedimethanol, glycerin, pyrolysis oil, motor oil, vacuum gas oil, atmospheric gas oil, light cycle oil, decahydronaphthalene (Decalin), heavy aromatics and heavy aromatics mixtures, water, and mixtures thereof.

5. The process of claim 1, wherein the liquefied waste plastic stream has a viscosity of less than 500 cP immediately prior to being introduced into the FCC unit and/or into the hydrocracking unit.

6. The process of claim 1, wherein the liquefied waste plastic stream has a halogen content not more than 100 ppm; or
wherein the process further comprises removing one or halogens from the liquified waste plastic stream to form a halogen-depleted liquified waste plastic stream, optionally, wherein the removing of one or more halogens comprises sparging a stripping gas into the liquified waste plastic stream to produce a multi-phase mixture and removing at least a portion of the halogens in a gas stream from the multi-phase mixture.

7. The process of claim 1, further comprising introducing a refinery stream into the FCC unit along with the liquified waste plastic stream, optionally, wherein the refinery stream comprises one or more of atmospheric gas oil, vacuum gas oil, and/or hydrocracker gas oil; and, optionally,
wherein the refinery stream and liquified waste plastic stream are mixed to form a combined feedstock stream before being introduced into the FCC unit, or
wherein the refinery stream and the liquified waste plastic stream are introduced into an FCC reactor of the FCC unit using different nozzles and/or at different locations in the FCC reactor.

8. The process of claim 1, wherein at least a portion of the liquified waste plastic stream is introduced to the FCC unit without being pyrolyzed.

9. The process of claim 1, further comprising pyrolyzing at least a portion of the liquified waste plastic to thereby provide at least a recycled content pyrolysis oil (r-pyoil) and a recycled content pyrolysis gas (r-pygas);
and further comprising: (i) combining at least a portion of the r-pyoil with at least a portion of the waste plastic before or during the liquifying, and/or (ii) introducing at least a portion of the r-pyoil into the FCC unit, and/or (iii) combining at least a portion of the r-pyoil with at least a portion of the liquified waste plastic stream before introducing into the liquified waste plastic into the FCC unit, and/or (iv) introducing at least a portion of the r-pyoil into an atmospheric distillation unit (ADU) to thereby produce one or more recycled content refinery streams, optionally, wherein the r-pyoil is introduced into the ADU with crude oil, and/or wherein the one or more recycled content refinery streams comprises an ADU bottoms stream, an atmospheric gas oil (AGO) stream, and/or other ADU products streams.

10. The process of claim 9, wherein the one or more recycled content refinery streams comprises an ADU bottoms stream and the process further comprises introducing the ADU bottoms stream to a vacuum distillation unit to thereby produce at least a heavy vacuum gas oil (HVGO) stream and a light vacuum gas oil (LVGO) stream, and, optionally, further comprising introducing the LVGO stream to the FCC unit, and/or further comprising hydrocracking at least a portion of the HVGO stream to thereby produce an HDC naphtha stream and/or an HDC gas oil stream, and,
optionally, further comprising introducing at least a portion of the HDC gas oil stream into the FCC unit.

11. The process of claim 1, further comprising combining a recycled content FCC light naphtha (r-FCC light naphtha) stream produced from the FCC unit and/or a recycled content hydrocracker naphtha (r-HDC naphtha) stream from the hydrocracking unit with a hydrocarbon feedstock, and introducing the hydrocarbon feedstock to a steam cracking facility to thereby produce at least a recycled content pyrolysis gasoline (r-pyrolysis gasoline), and, optionally, further comprising introducing at least a portion of the r-pyrolysis gasoline to an aromatics complex.

12. The process of claim 1, wherein at least a portion of the liquified waste plastic stream is introduced into the FCC unit, and wherein the FCC unit produces one or more recycled content FCC streams comprising a recycled content LPG stream (r-FCC LPG), one or more recycled content naphtha streams (r-FCC naphtha), and/or a recycled content cycle oil stream (r-FCC Cycle Oil), optionally, wherein the one or more r-FCC naphtha streams comprises at least an r-FCC light naphtha stream and an r-FCC heavy naphtha stream, and, optionally, further comprising: (i) introducing at least a portion of the r-FCC light naphtha stream into a steam cracking facility to thereby produce at least a recycled content pyrolysis gasoline (r-pyrolysis gasoline), and/or (ii) introducing at least a portion of the r-pyrolysis gasoline to an aromatics complex, and/or (iii) introducing at least a portion of the r-FCC heavy naphtha stream to an aromatics complex, and/or (iv) hydrotreating at least a portion of the r-FCC heavy naphtha stream before introducing to the aromatics complex, and/or (v) reforming at least a portion of the r-FCC heavy naphtha stream to form a recycled content reformate (r-reformate) stream comprising recycled content para-xylene (r-pX), and introducing the r-reformate stream to the aromatics complex, and/or (vi) processing at least a portion of the r-FCC (heavy) naphtha stream, the r-reformate stream, and/or the r-pyrolysis gasoline stream within an aromatics complex to produce a recycled content para-xylene (r-pX) stream comprising at least 85 weight percent para-xylene, optionally, wherein the processing comprises subjecting one or more components of the reformate to at least one of a separation step, an alkylation step, a transalkylation step, a toluene disproportionation step, and an isomerization step.

13. The process of claim 1, wherein the liquifying step comprises melting waste plastic to form a liquified waste plastic stream; and the process further comprises:
(a) dehalogenating at least a portion of the liquified waste plastic stream to form a halogen-depleted liquified waste plastic stream; and
(b) introducing at least a portion of the halogen-depleted liquified waste plastic stream into a fluidized catalytic cracker (FCC) unit and/or a hydrocracking unit.

14. The process of claim 1, comprising:
(a) liquifying waste plastic to form a liquified waste plastic stream;
(b) pyrolyzing at least a first portion of the liquified waste plastic to thereby provide a recycled content pyrolysis oil (r-pyoil); and
(c) catalytically cracking at least a second portion of the liquified waste plastic,
wherein at least a portion of the r-pyoil is combined with at least a portion of the waste plastic before or during the liquifying (a), and/or
wherein at least a portion of the r-pyoil is combined with at least a portion of the liquified waste plastic after the liquifying (a).

15. The process of claim 1, further comprising producing recycled content para-xylene (r-pX), the method comprising:
(a) liquifying waste plastic to form a liquified waste plastic stream;
(b) introducing at least a portion of the liquified waste plastic stream and a refinery stream into a fluidized catalytic cracker (FCC) unit and/or a hydrocracking (HDC) unit;
(c) recovering a recycled content FCC naphtha (r-FCC naphtha) stream from the FCC unit and/or a recycled content HDC naphtha (r-HDC naphtha) stream from the HDC unit, wherein the r-FCC naphtha stream and/or the r-HDC naphtha stream comprises at least one aromatics-containing stream and/or wherein the r-FCC naphtha stream and/or the r-HDC naphtha stream are further processed to produce at least one aromatics-containing stream; and
(d) processing at least a portion of the at least one aromatics-containing stream within an aromatics complex to produce an r-pX-containing product stream comprising at least 85 weight percent para-xylene.
